(19) United States
(12) Patent Application Publication
(10) Pub. No.: US 2020/0027310 A1
(43) Pub. Date: Jan. 23, 2020

(54) METHOD AND SYSTEM FOR CASCADING SYMBOL GAMES

(71) Applicant: EPIC TECH, LLC, LAVONIA, GA (US)

(72) Inventors: STEVEN WESLEY DAVIS, SUWANEE, GA (US); DONALD JAMES ROLLO, III, DACULA, GA (US)

(21) Appl. No.: 15/687,721

(22) Filed: Aug. 28, 2017

(51) Int. Cl. G07F 17/32

(52) U.S. Cl. CPC G07F 17/3267; G07F 17/3213; G07F 17/323; G07F 17/3258; G07F 17/3288

(57) ABSTRACT

In an embodiment, the invention is directed to a gaming system which designates at least one symbol as a trigger symbol, displays a plurality of symbols in a plurality of symbol display positions, and determines if any of the displayed symbols form any winning symbol combinations. If the displayed symbols form at least one winning symbol combination, the system displays an award and determines if any winning symbol combination corresponds with at least one designated trigger symbol. If this is the case, the system removes at least one symbol which does not correspond with the designated trigger symbol from the plurality of symbol display positions, optionally cascades symbols downward, and then determines if any of the displayed symbols form any winning symbol combinations. If the displayed symbols form at least one winning symbol combination, the system displays one of a plurality of awards for each displayed winning symbol combination. If any empty symbol display positions remain, the system displays one of a plurality of new symbols at each of the empty symbol display positions. The system then repeats the steps until the game ends.

### BACKGROUND

The present invention relates to gaming machines for the playing of games of skill or chance and, more particularly, to special features of games which may be offered on such machines. Standard gaming devices and games display (mechanically, electronically simulated, or otherwise) a number of reels marked with a number of symbols. In a standard game, the reels spin and stop randomly. If the pattern of symbols displayed on the stopped reels corresponds to a predetermined winning pattern, the device awards the player with a prize. In some games, a skill element is required in order to win the game, such as nudging one or more of the reels in a particular direction in order to create a winning pattern.

Some gaming systems provide cascading symbol games, also known as tumbling reel games. In an exemplary game, a gaming system generates and displays a plurality of symbols in a symbol display position matrix or grid. This symbol display position matrix may include a plurality of symbol display positions. Each symbol display position is associated with a specific row and a specific column of the symbol display position matrix. In a standard cascading symbol game, the reels spin, stop to display a set of symbols in the positions, and then the gaming machine evaluates the displayed symbols to determine if there is a winning combination of symbols displayed. If so, the system displays and/or provides an award for each winning symbol combination formed. In a standard cascading symbol game, the gaming system then removes the displayed symbols that form the winning symbol combination(s), creating one or more empty symbol display positions. The gaming system then shifts one or more of the remaining displayed symbols downward into one or more of the created empty symbol display positions (i.e. the “cascading” or “tumbling” effect). If any empty symbol display positions remain, the gaming system then generates and displays a new symbol for each remaining empty symbol display position. The gaming machine or system then evaluates the displayed symbols and provides an award for any winning symbol combinations formed. If winning symbol combinations continue to be formed, the gaming machine repeats the steps of removing winning symbols, shifting symbols, generating new symbols, and evaluating generated symbols until no winning symbol combinations remain.

Machines and games that offer novel and stimulating variations on the basic reel-based games and/or standard cascading games, yet comply with the strict regulatory restrictions set forth for the gaming industry, are eagerly sought after. There is intense competition between gaming manufacturers to innovate, and particularly for games that may increase the number of winning symbol combinations generated per game. These types of games have the benefit of providing multiple awards to a player for a single wager on a play of a game. These types of games also draw player interest and create an exciting overall game experience. As such, vast amounts of time, energy, and financial resources are put into the development of new gaming concepts such as those described and claimed herein.

### SUMMARY OF THE INVENTION

In an embodiment, the invention is directed to a gaming system comprising: at least one input device; at least one display device; and at least one processor which is configured to: receive a request, via the input device, from a user to play a first game; in response to the request, designate at least one symbol as a trigger symbol; in response to the request, display, on the display device, one of a plurality of symbols at each of a plurality of symbol display positions, wherein the plurality of symbol display positions form at least three columns and at least three rows including a first row, a second row positions adjacent to the first row, and a third row positioned adjacent to the second row; determine if any of the displayed symbols form any winning symbol combinations; if the displayed symbols form at least one winning symbol combination, display one of a plurality of awards for each displayed winning symbol combination; determine if any winning symbol combination corresponds with at least one designated trigger symbol; if at least one winning symbol combination corresponds with at least one designated trigger symbol, remove at least one symbol which does not correspond with the designated trigger symbol from the plurality of symbol display positions; for each of any symbols removed from the first row of the symbol display positions, reposition at least one of the remaining displayed symbols to at least another one of the symbol display positions to create at least one empty symbol display position; for each of any symbols removed from the second row of the symbol display positions, reposition at least one of the remaining displayed symbols to at least another one of the symbol display positions to create at least one empty symbol display position; determine if any of the displayed symbols form any winning symbol combinations; if the displayed symbols form at least one winning symbol combination, display one of a plurality of awards for each displayed winning symbol combination; if any empty symbol display positions remain, display one of a plurality of symbols at each of the empty symbol display positions; and repeat the steps.

In another embodiment, the invention is directed to a gaming system comprising: at least one input device; at least one display device; and at least one processor which is configured to: receive a request, via the input device, from a user to play a first game; in response to the request, designate a first symbol as a trigger symbol; in response to the request, display, on the display device, one of a plurality of symbols at each of a plurality of symbol display positions, wherein the plurality of symbol display positions form at least three columns and at least three rows including a first row, a second row positions adjacent to the first row, and a third row positioned adjacent to the second row; determine if any of the displayed symbols form any winning symbol combinations; if the displayed symbols form at least one winning symbol combination, display one of a plurality of awards for each displayed winning symbol combination; determine if any winning symbol combination corresponds with at least one designated trigger symbol; if at least one winning symbol combination corresponds with at least one designated trigger symbol, remove at least one symbol which does not correspond with the designated trigger symbol from the plurality of symbol display positions; for each of any symbols removed from the first row of the symbol display positions, reposition at least one of the remaining displayed symbols to at least another one of the symbol display positions to create at least one empty symbol display position; for each of any symbols removed from the second row of the symbol display positions, reposition at least one of the remaining displayed symbols to at least another one of the symbol display positions to create at least one empty symbol display position; determine if any of the displayed symbols form any winning symbol combinations; if the displayed symbols form at least one winning symbol combination, display one of a plurality of awards for each displayed winning symbol combination; remove the designation of the first symbol as a trigger symbol and designate a different symbol as a trigger symbol; if any empty symbol display positions remain, display one of a plurality of symbols at each of the empty symbol display positions; and repeat.

In another embodiment, the invention is directed to a gaming system comprising: at least one input device; at least one display device; and at least one processor which is configured to: receive a request, via the input device, from a user to play a first game; in response to the request, designate a first symbol as a trigger symbol; in response to the request, display, on the display device, one of a plurality of symbols at each of a plurality of symbol display positions, wherein the plurality of symbol display positions form at least three columns and at least three rows including a first row, a second row positions adjacent to the first row, and a third row positioned adjacent to the second row; determine if any of the displayed symbols form any winning symbol combinations; if the displayed symbols form at least one winning symbol combination, display one of a plurality of awards for each displayed winning symbol combination; determine if any winning symbol combination corresponds with at least one designated trigger symbol; if at least one winning symbol combination corresponds with at least one designated trigger symbol, remove at least one symbol which does not correspond with the designated trigger symbol from the plurality of symbol display positions; for each of any symbols removed from the first row of the symbol display positions, reposition at least one of the remaining displayed symbols to at least another one of the symbol display positions to create at least one empty symbol display position; for each of any symbols removed from the second row of the symbol display positions, reposition at least one of the remaining displayed symbols to at least another one of the symbol display positions to create at least one empty symbol display position; determine if any of the displayed symbols form any winning symbol combinations; if the displayed symbols form at least one winning symbol combination, display one of a plurality of awards for each displayed winning symbol combination; designate an additional different symbol as a trigger symbol; if any empty symbol display positions remain, display one of a plurality of symbols at each of the empty symbol display positions; and repeat.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIGS. 1-5 are front views of various embodiments of the gaming system disclosed herein illustrating play of a cascading symbols game;

FIG. 6 is a flow chart showing an exemplary process for operating a gaming system of the present invention;

FIGS. 7-10 are block diagrams of the system in embodiments of the present invention; and

FIGS. 11-12 show front views of various embodiments of stand-alone gaming machines of the invention.

### DESCRIPTION OF SOME EMBODIMENTS

Reference will now be made in detail to embodiments of the present systems and methods, one or more examples of which are illustrated in the accompanying drawings. Each example is provided by way of explanation, not limitation of the present system. In fact, it will be apparent to those skilled in the art that modifications and variations can be made to the present system and methods without departing from the scope or spirit thereof. For instance, features illustrated or described as part of one embodiment may be used in another embodiment to yield a still further embodiment. Thus, the present system and methods cover such modifications and variations as come within the scope of the appended claims and their equivalents.

While certain of the embodiments described herein are directed to playing a cascading symbol game as a primary or base game, it should be appreciated that the present disclosure may additionally or alternatively be implemented as a secondary or bonus game. Moreover, while the player's credit balance, the player's wager and/or any awards may be displayed as an amount of monetary credits or currency in the embodiments described herein, the player's credit balance, wager, or any awards provided to the player may be for non-monetary credits, promotional credits, and/or player tracking points or credits.

Gaming systems generally require a player to place or make a wager or provide some form of consideration to activate the primary or base game. Typical systems provide one award for each game. Advantageously, the present invention provides a game that has a repeating cascade feature which, when triggered, may provide the player with multiple opportunities to win within a single game and for a single wager. These types of games are highly sought after due to the increased player excitement that is generated.

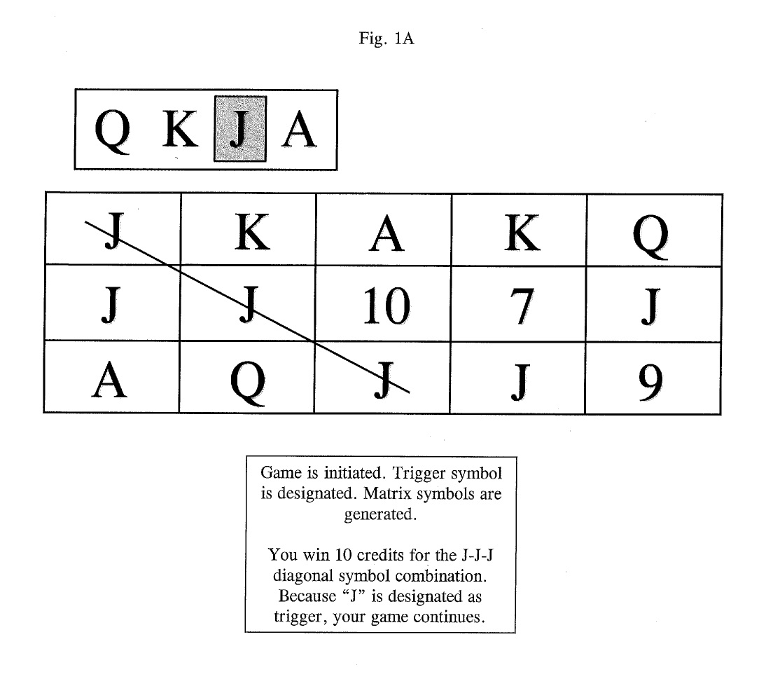

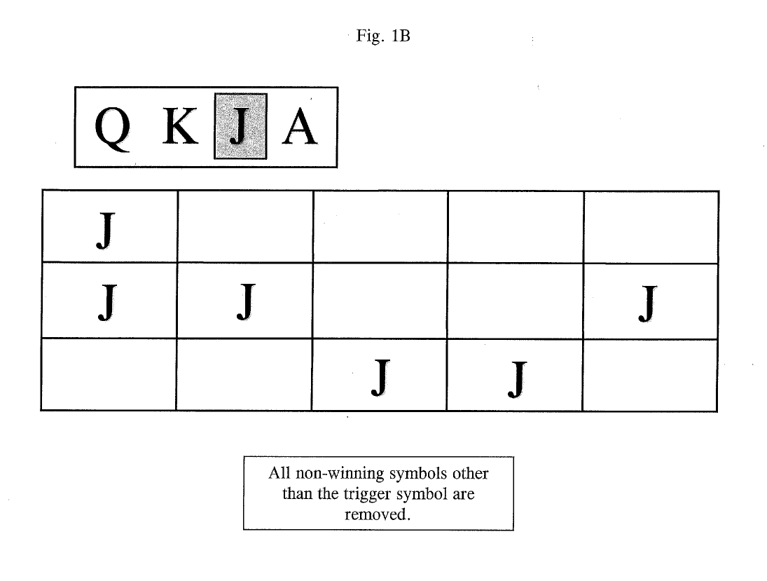

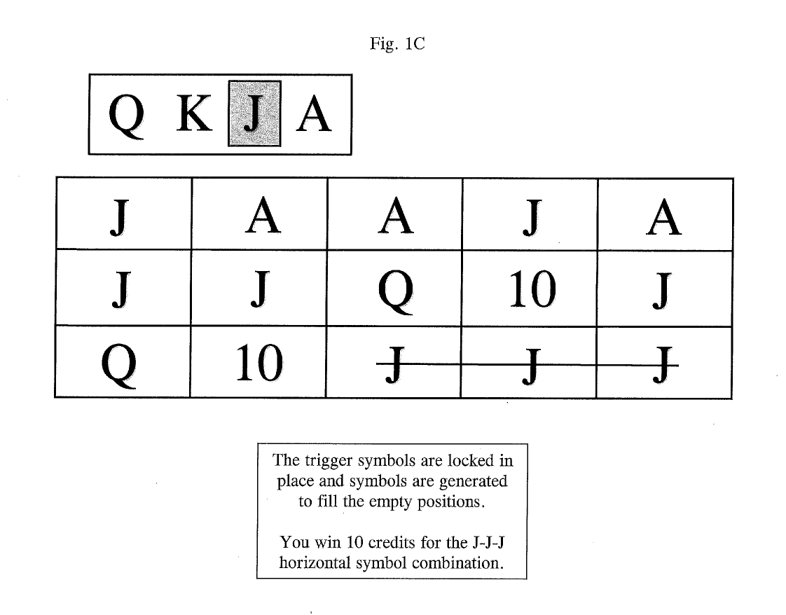

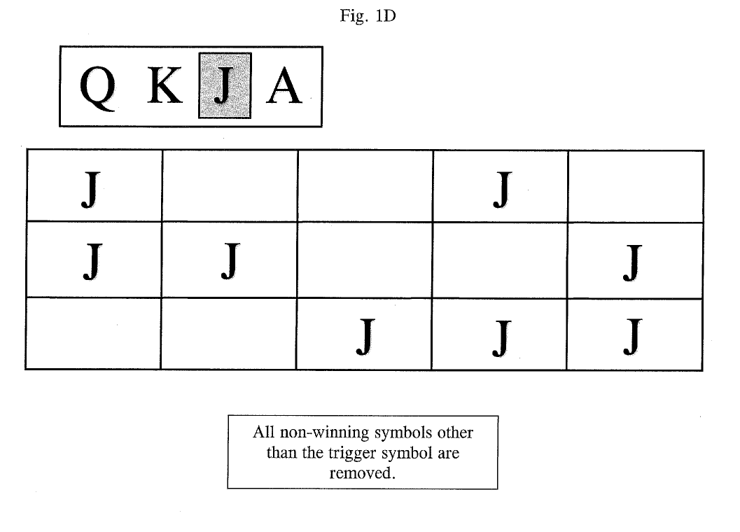

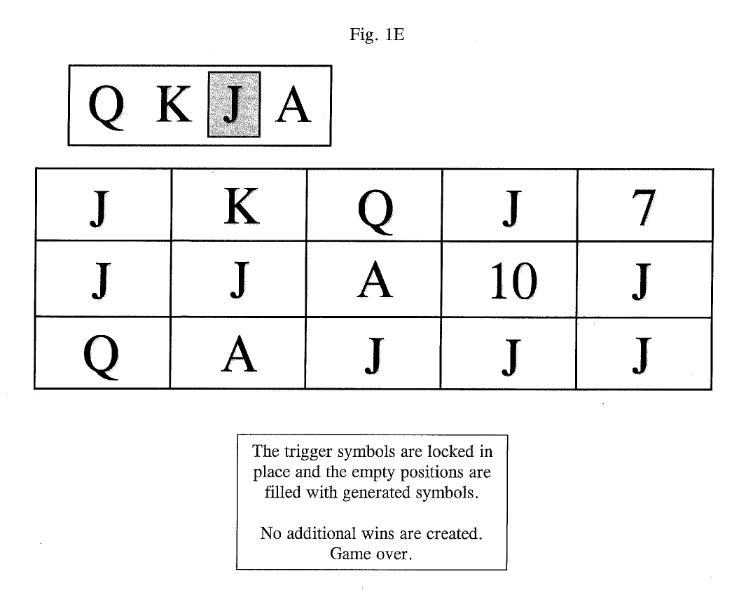

The present invention is directed generally to a novel and exciting gaming machine, system, and methodology. Generally speaking, as shown in FIG. 1A, the invention is directed to a game based upon one or more simulated rotatable reels, displayed in a matrix format 110 of columns 116, 117, 118, 119, and 120 and rows 111, 112, 113. While it is common to see 5 columns and 3 rows displayed in a matrix, any number of rows or columns may be utilized in the invention. In some embodiments, three, four, five, or any number of reels may be displayed. In an embodiment, the number of rows displayed at any given time may be three, four, five or any number of rows. In some embodiments, for example, the matrix 110 may display five reels/columns and three rows. In another embodiment, the matrix may display five reels/columns and four rows. In still another embodiment, the matrix 110 may display six reels/columns and five rows. In a further embodiment, the matrix 110 may display seven reels/columns and five rows or five reels/columns and seven rows. As can be seen, any numbered combination of rows and columns may be utilized. In an embodiment, each reel is displayed as a vertical matrix column 116, 117, 118, 119, and 120 and contains one or more symbol positions 121 within each column.

Additionally shown in FIG. 1A is a designated symbol area 115. The designated symbol area 115 may be displayed anywhere within the display of the game. In the embodiment shown in FIG. 1A, the designated symbol area 115 is shown in the upper left side of the display, in a box above the matrix. However, this positioning is not determinative and the designated symbol area 115 may be positioned elsewhere. Similarly, the designated symbol area 115 is shown as containing four (4) symbols 122, 123, 124, and 125. However, any number of symbols may be displayed within the designated symbol area 115. In an embodiment two (2) or three (3) symbols may be displayed. In an embodiment, the symbols displayed in the designated symbol area 115 are a subset of the symbols available for use within the matrix 110 of symbols. For example, if the symbols used in a standard deck of playing cards are used as the symbols for the base game matrix, the subset of symbols shown in the designated symbol area 115 may be one or more face cards. Similarly, the designated symbol area 115 may designate one or more types of symbols rather than specific symbols. For example, the designated symbol area 115 may designate symbols of a particular color, symbols of a particular suit, or symbols that have something else in common or are related. In some embodiments, the designated symbol area regenerates and/or displays different symbols for each game. In other embodiments, the designated symbol area regenerates and/or displays different symbols for each cascade within a game (as will be more fully described herein).

In an embodiment, one or more of the symbols in the designated symbol area 115 is highlighted, selected, or otherwise identified as active 130. In FIG. 1A, the active 130 designated symbol is shown as a “J”. In other embodiments, all symbols in the designated symbol area 115 are active. In still other embodiments, a rule is set forth with regard to which symbols within the designated symbol area 115 are active—for example, the leftmost symbol may be the active symbol or the middle symbol may be the active symbol. Similarly, in an embodiment, a higher bet level could activate multiple symbols, whereas a lower bet level only activates a single designated symbol. In an embodiment, a symbol within the designated symbol area 115 only becomes active upon a triggering event.

In an embodiment of a first game, a participant initiates a play of the game. The processor receives a game request from the participant. The processor may then display a set of symbols within the matrix 110 using any of the processes described herein. Referring to FIG. 1, the processor may display a set of symbols in a matrix 110 comprising three rows and five columns. The symbols may be shown to rotate vertically within the columns, spinning as reels, and eventually coming to stop (or being stopped by the player) to display the final set of symbols.

Before, after, or simultaneous with the display of the matrix 110 symbols, the processor may also determine, select, and/or display symbols within the designated symbol area 115 and, optionally, display certain of those symbols as active 130. In an embodiment, the processor may display a highlight or background color cycling through the symbols within the designated symbol area 115, temporarily highlighting each one until the reels stop spinning and the highlight 130 ends on a particular symbol, activating it. In an embodiment, the processor may display various symbols cycling through the designated symbol area 115 during the reel spinning process, wherein the symbols stop cycling through the designated symbol area 115 when or near the time that the reels stop. In an embodiment, both the highlight and the symbols within the designated symbol area 115 cycle while the matrix 110 reels spin and stop when or near the time that the matrix reels stop. In an embodiment, the timing on selection of the symbols within the designated symbol area 115 and/or the highlighting of one or more of those symbols as active 130 is related to the timing of the matrix reel spin, but is not the same as the timing of the matrix reel spin. For example, the cycling of the symbols or highlight within the designated symbol area 115 may occur at a slower or faster rate than the spinning of the matrix reels. Similarly, the cycling of the symbols or highlight within the designated symbol area 115 may begin and/or end before or after the spinning of the matrix reels. In an embodiment, the cycling of the symbols and/or highlight within the designated symbol area 115 may be of the same speed and duration of the matrix reel spin.

In an embodiment, the processor may then determine whether any winning symbol combinations have been created within the matrix 110 symbols. In FIG. 1A, for example, three diagonal “J”s are shown as a first winning combination 114. The system may then display and/or award the player with a prize associated with the winning combination 114. If there is no winning symbol combination, the game is over.

If there is a winning symbol combination, the processor may also determine if the winning symbol combination 114 corresponds with the active 130 symbol within the designated symbol area 115. In an embodiment, correspondence may mean that the active symbol 130 is the same symbol that is displayed in the winning symbol combination 114 (for example, both are “J”s in the example set forth in FIG. 1A). In another embodiment, the winning symbol combination 114 may corresponds with the active 130 symbol because they share the same color, the same symbol type, or some other corresponding relationship. In an embodiment, correspondence between the winning symbol combination 114 and the active symbol 130 will trigger the locking and/or cascading game features described herein.

If there is correspondence between the winning symbol combination 114 and the active symbol 130, the gaming system then determines whether any of the displayed symbols qualify to be removed. That is, the gaming system determines whether to remove any symbols currently displayed at the plurality of symbol display positions. If no displayed symbols qualify to be removed, the gaming system does not remove any of the plurality of symbols, terminates the play of the game and awaits another wager on another play of the game. Similarly, if there is no correspondence between the winning symbol combination 114 and the active symbol 130 (i.e. if the winning symbol combination 114 did not contain a “J”, as “J” is the active symbol 130 in FIG. 1A), a prize is awarded for the winning symbol combination, and then the game ends. In an embodiment, additional consideration or a new wager may be required to activate a new game.

On the other hand, if one or more of the displayed symbols qualify to be removed, the gaming system removes such displayed symbols. In an embodiment, all non-winning symbols are removed from the matrix 110. In another embodiment, some but not all non-winning symbols are removed from the matrix 110. In an embodiment, winning symbols are never removed from the matrix. In another embodiment, any matrix symbols that correspond with active symbol 130 are not removed from the matrix.

As shown in FIG. 1B, because the active symbol 130 was a “J” and the winning symbol combination 114 involved a “J”, all symbols other than the “J”s are removed from the matrix. It should be appreciated that, by removing one or more displayed symbols from the symbol display position matrix, the gaming system creates one or more empty symbol display positions 135, shown in FIG. 1B. In an embodiment, the game system then locks the displayed symbols in the matrix into their current positions and generates new symbols, again using any method described herein, to fill the empty symbol display positions 135. The newly generated symbols may, optionally, rotate vertically through the column as the reels spin. In another embodiment, the newly generated symbols may move into an empty symbol position without rotating further. In an embodiment, the newly generated symbols appear at the top of the matrix and then cascade downward and/or from side-to-side until they find the lowest empty symbol position to occupy. In yet another embodiment, the newly generated symbols merely appear in empty symbol positions without spinning or cascading. In an embodiment, the locked symbols (“J”s in the example in FIG. 1B) do not spin or cascade, and instead remain stationary. In an embodiment, the active symbol 130 remains the same during this symbol generation process.

In an embodiment, once new symbols have been generated to fill the empty symbol display positions 135, the processor may then determine whether any winning symbol combinations have been created within the matrix 110. In FIG. 1C, for example, three horizontal “J”s are shown as a second winning combination 140. The system may then display and/or award the player with a prize associated with the winning combination 140. If there is no winning symbol combination, the game is over. If there is a winning symbol combination, the processor may also determine if the second winning symbol combination 140 corresponds with the active 130 symbol within the designated symbol area 115. If there is correspondence between the second winning symbol combination 140 and the active symbol 130, the gaming system may then determine whether any of the displayed symbols qualify to be removed. If no displayed symbols qualify to be removed, the gaming system does not remove any of the plurality of symbols, terminates play of the game and awaits another wager on another play of the game. Similarly, if there is no correspondence between the second winning symbol combination 140 and the active symbol 130 (i.e. if the second winning symbol combination 140 did not contain a “J”, as “J” is the active symbol 130 in FIG. 1C), the game ends.

On the other hand, if one or more of the displayed symbols qualify to be removed, the gaming system removes such displayed symbols, as shown in FIG. 1D. As shown in FIG. 1D, because the active symbol 130 was a “J” and the second winning symbol combination 140 involved a “J”, all symbols other than the “J”s are removed from the matrix, creating one or more empty symbol display positions 145. In an embodiment, the locked symbols from the first winning symbol combination 114 remain locked and the additional “J”s that were generated are also locked in position. Alternatively, only the newly generated “J”s may become locked in an embodiment and the original “J”s may be removed or may cascade downward. In any event, the processor then generates new symbols, again using any method described herein, to fill the empty symbol display positions 145. FIG. 1E shows a display which includes the newly generated symbols to fill the empty symbol display positions 145. The processor may then determine whether any winning symbol combinations have been created within the matrix symbols. This process may repeat until there are no additional winning symbol combinations. In the example shown in FIG. 1E, no additional winning symbol combinations have been created within the matrix symbols. Accordingly the game ends and the system awaits initiation of a new game.

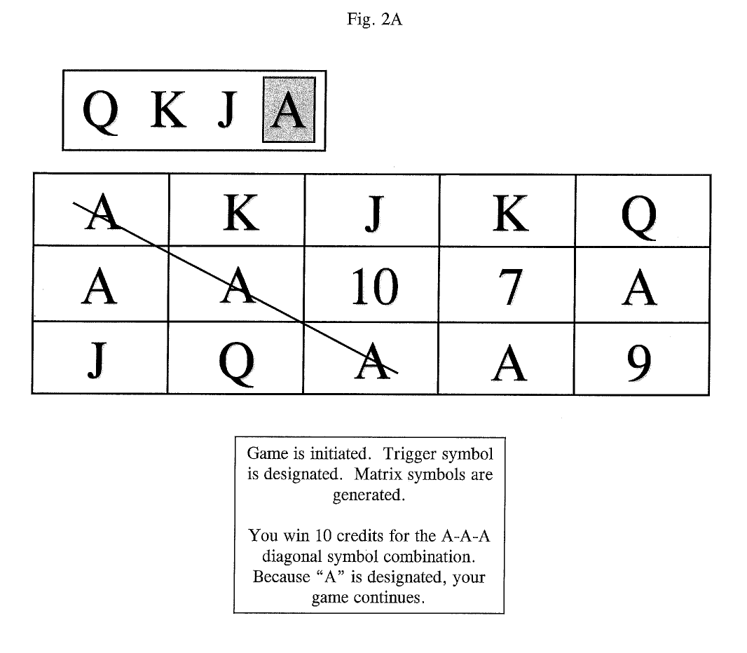

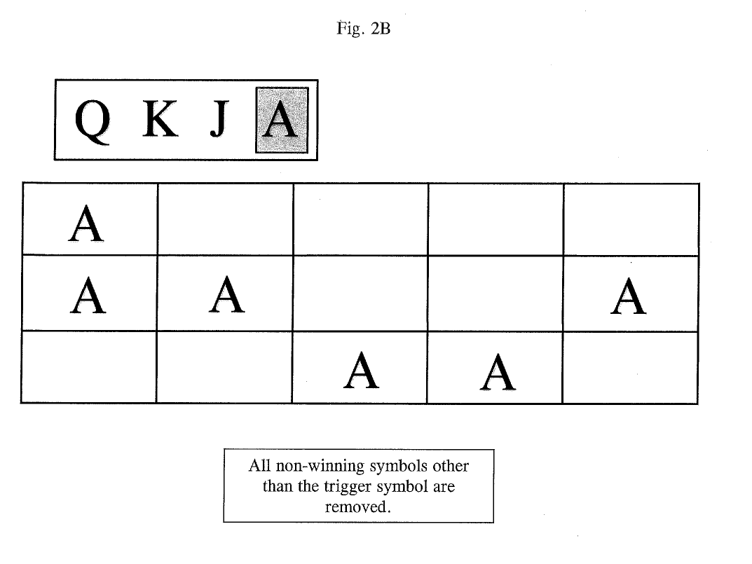

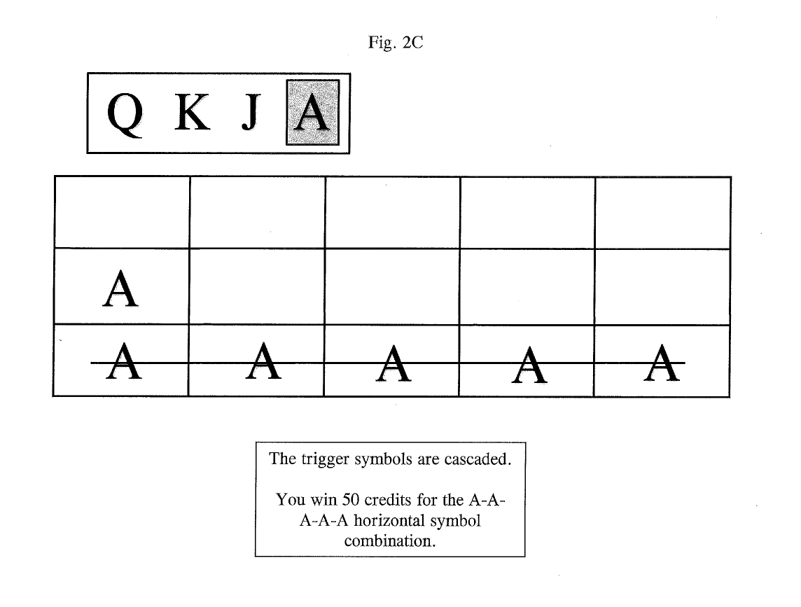

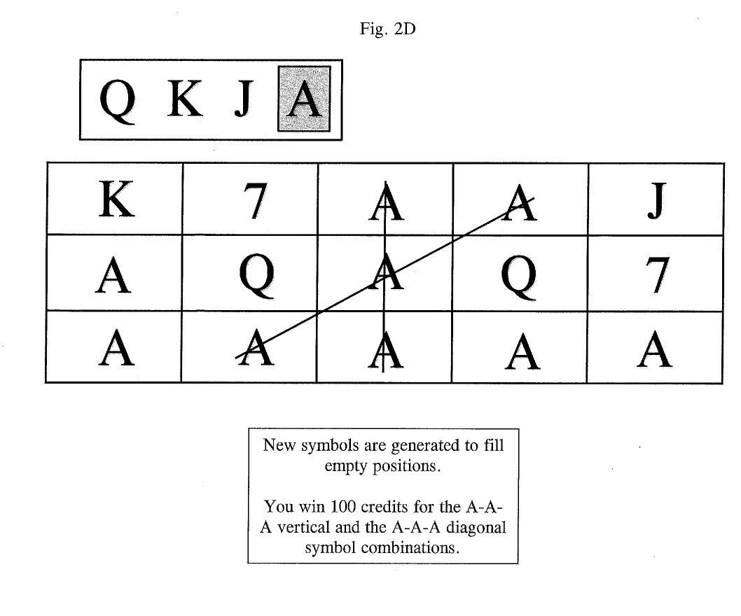

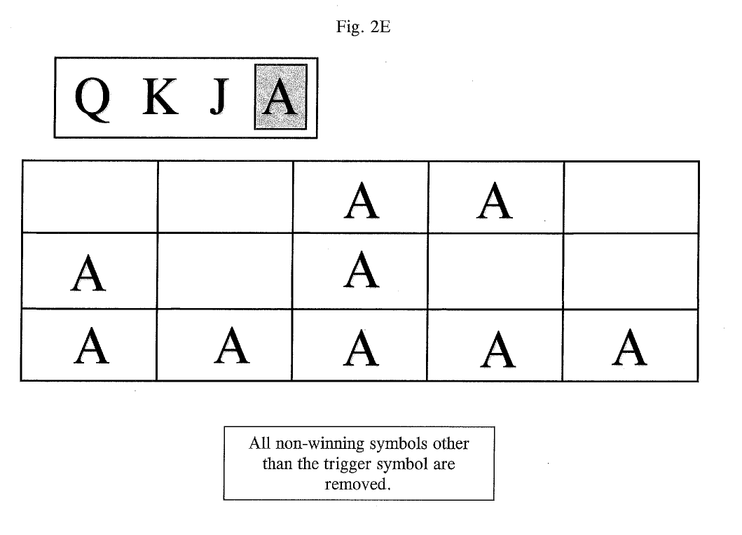

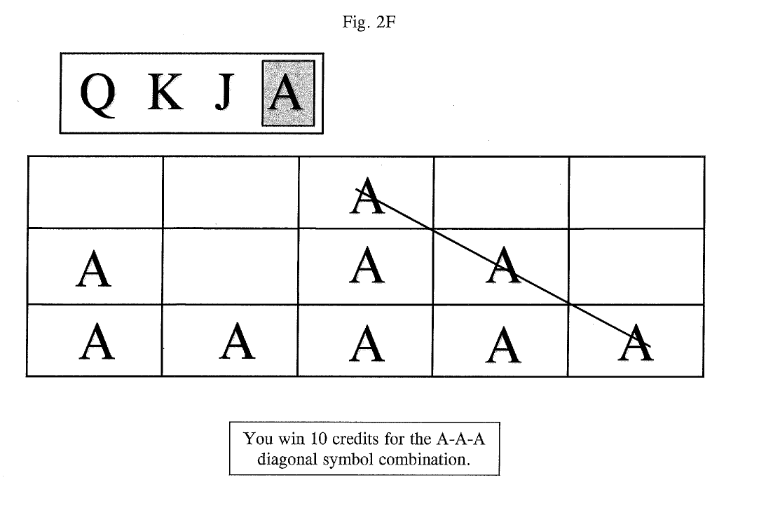

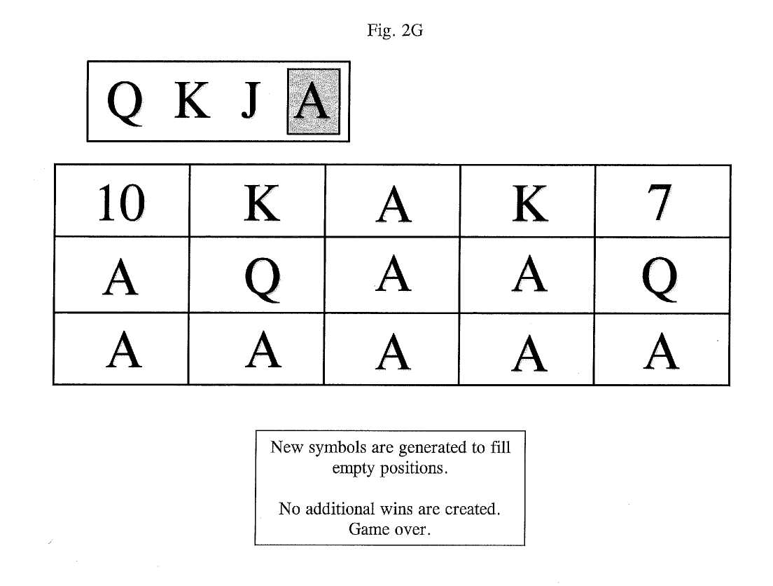

Another embodiment of the game is shown in FIG. 2. In this embodiment, the processor receives a game request from the participant to initiate game play. The processor may then display a set of symbols within the matrix 210 using any of the processes described herein. The processor may also display symbols within the designated symbol area 215 and display certain of those symbols as active 230. In this example, the active symbol 230 is shown as an “A.” In an embodiment, the processor may then determine whether any winning symbol combinations have been created within the matrix symbols. In FIG. 2A, for example, three diagonal “A”s are shown as a first winning combination 214. The system may then display and/or award the player with a prize associated with the winning combination 214. If there is no winning symbol combination, the game is over. If there is a winning symbol combination, the processor may also determine if the winning symbol combination 214 corresponds with the active 230 symbol within the designated symbol area 215.

If there is correspondence between the winning symbol combination 214 and the active symbol 230, the gaming system then determines whether any of the displayed symbols qualify to be removed. If no displayed symbols qualify to be removed, the gaming system does not remove any of the plurality of symbols, terminates the play of the game and awaits another wager on another play of the game. Similarly, if there is no correspondence between the winning symbol combination 214 and the active symbol 230, the game ends. On the other hand, if one or more of the displayed symbols qualify to be removed, the gaming system removes such displayed symbols, leaving empty symbol positions 235. This is shown in FIG. 2B. Because the active symbol 230 was a “A” and the winning symbol combination 214 involved a “A”, all symbols other than the “A”s are removed from the matrix.

In this embodiment, however, rather than the remaining displayed symbols 250 (the “A”s in FIG. 2) being locked in position, the remaining displayed symbols 250 cascade. The cascade may be downward, such that each symbol 250 moves to any empty position directly below its current position. Similarly, the cascade may direct the remaining symbols 250 sideways or upward, or any mixture or combination of directions. A rule may be created regarding the cascade—for example, the remaining symbols 250 may each move one position, but not two positions, or the remaining symbols 250 of a particular column may move in one direction while the remaining symbols 250 of a different column may move in a different direction.

FIG. 2C illustrates the remaining displayed symbols 250 after their cascade downward, each moving to any empty symbol positions 235 below their previous symbol position. In an embodiment, the processor may then determine whether any new winning symbol combinations have been created within the matrix symbols due to the cascade. This may occur before or after generation of new symbols to fill the empty symbol positions 235. In an embodiment, it occurs prior to generation of new symbols. As shown in FIG. 2C, a new winning combination has been created as a result of the cascade—five (5) horizontal “A”s have aligned, creating a new winning combination 236. In an embodiment, the new win is displayed and/or awarded to the player. In another embodiment, this determination may be made after the generation of new symbols.

In an embodiment, new symbols are generated to fill the empty symbol display positions 235. FIG. 2D illustrates the matrix 210 as filled with newly generated symbols. In an embodiment, the processor may again determine whether any winning symbol combinations have been created within the matrix after the generation of the new symbols. As shown in FIG. 2D, two new winning symbol combinations 255 are shown—three (3) vertical “A”s and three (3) diagonal “A”s. In an embodiment, the new win is displayed and/or awarded to the player.

Once again, if there is a winning symbol combination, the processor may also determine if the winning symbol combination 255 corresponds with the active symbol 230 within the designated symbol area 215. If there is correspondence between the winning symbol combination 255 and the active symbol 230, the game continues. The gaming system determines whether any of the displayed symbols qualify to be removed. If one or more of the displayed symbols qualify to be removed, the gaming system removes such displayed symbols, leaving empty symbol positions 260, shown in FIG. 2E. Because the active symbol 230 was an “A” and the winning symbol combinations 255 involved an “A”, all symbols other than the “A”s are removed from the matrix in this embodiment. The remaining displayed symbols 270 then cascade, in this example, downward. FIG. 2F illustrates the remaining displayed symbols 270 after their cascade, each moving to any empty symbol positions 235 below their previous symbol position. Note that in an embodiment, the first cascade could be a downward cascade and the second cascade could be a right-to-left cascade or an upward cascade. Any combination of directional cascade could be utilized. In an embodiment, the processor may then determine whether any winning symbol combinations have been created within the matrix symbols due to the cascade. As shown in FIG. 2F, a new diagonal A-A-A winning symbol combination 275 has been formed. In an embodiment, the win associated with the winning symbol combination 275 is displayed and/or awarded to the player.

In an embodiment, new symbols are then generated to fill the empty symbol display positions 260. FIG. 2G illustrates the matrix 210 as filled with newly generated symbols 280, each of which fills a previously empty symbol display position 260. In an embodiment, the processor may again determine whether any winning symbol combinations have been created within the matrix symbols after the generation of the new symbols 280. In the embodiment shown in FIG. 2G, no new winning symbol combinations were created after the generation of new symbols 280, so the game is over. If new winning symbol combinations had been created, the process would repeat.

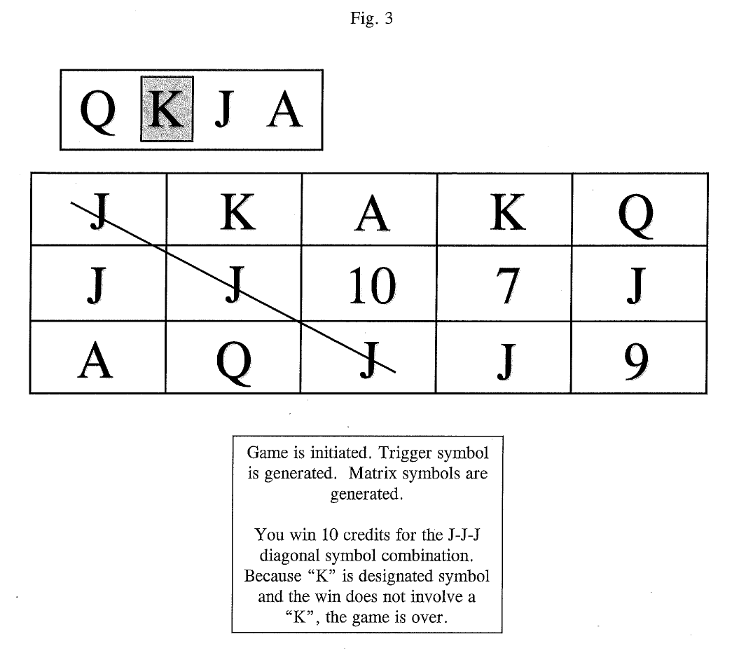

FIG. 3 illustrates an embodiment wherein the winning symbol combination 320 does not correspond with the active symbol 330 within the designated symbol area 315. In this embodiment, the processor displays randomly generated symbols in the matrix 310. In an embodiment, the processor determines whether any winning symbol combinations have been created within the matrix 310. In this embodiment, a winning symbol combination 320 has been created—three (3) “J”s in a diagonal pattern. In an embodiment, the win associated with the winning symbol combination 320 is displayed and/or awarded to the player. Because there was a winning symbol combination, the processor then, in this embodiment, determines whether the winning symbol combination 320 corresponds with the active symbol 330 within the designated symbol area 315. In this case, there is no correspondence. The active symbol 330 is a “K” and the winning symbol combination 320 does not involve a “K”. Therefore, once the win associated with the winning symbol combination 320 has been awarded, the game is over. The processor awaits a new request for initiation of a game.

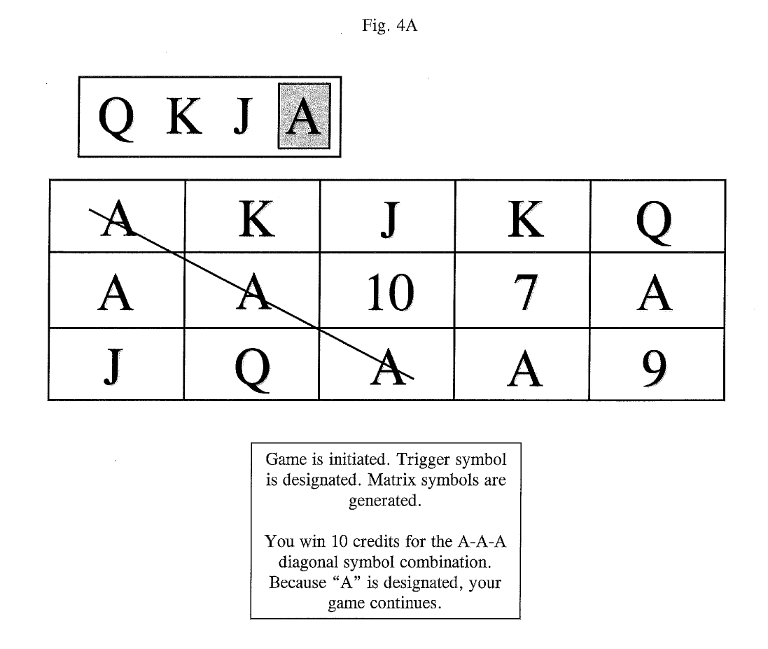

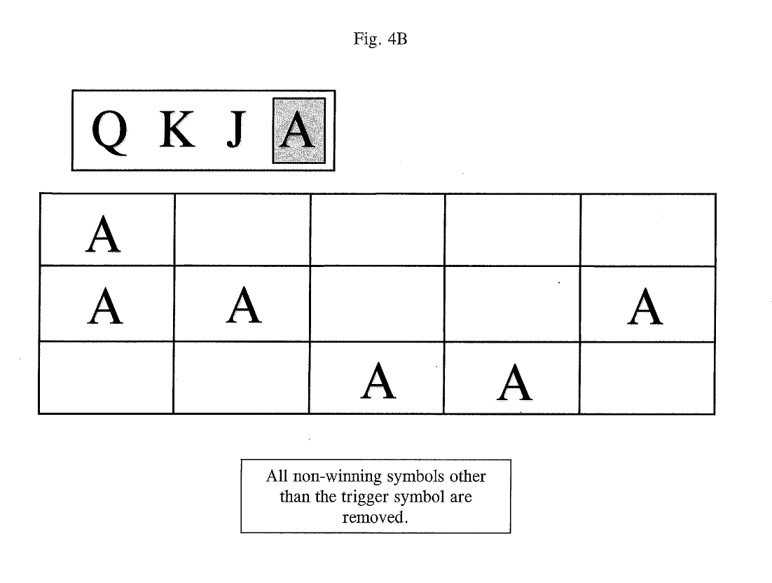

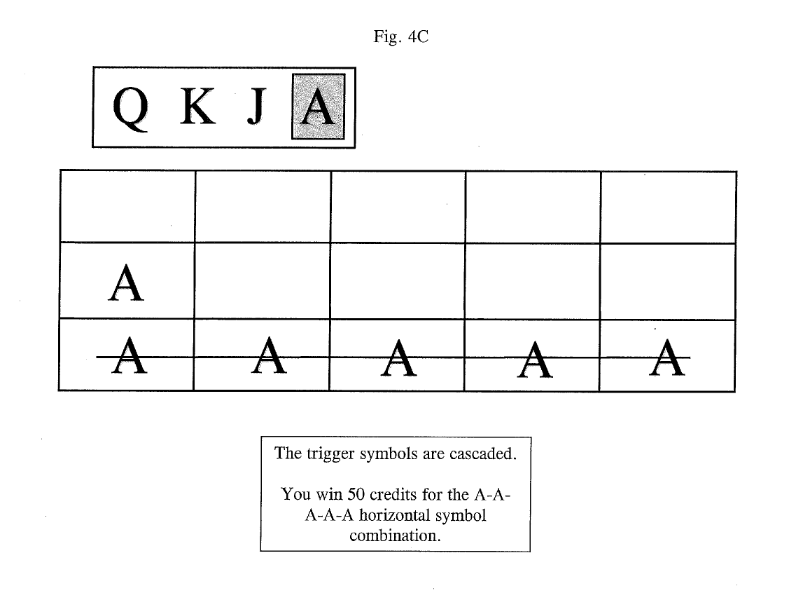

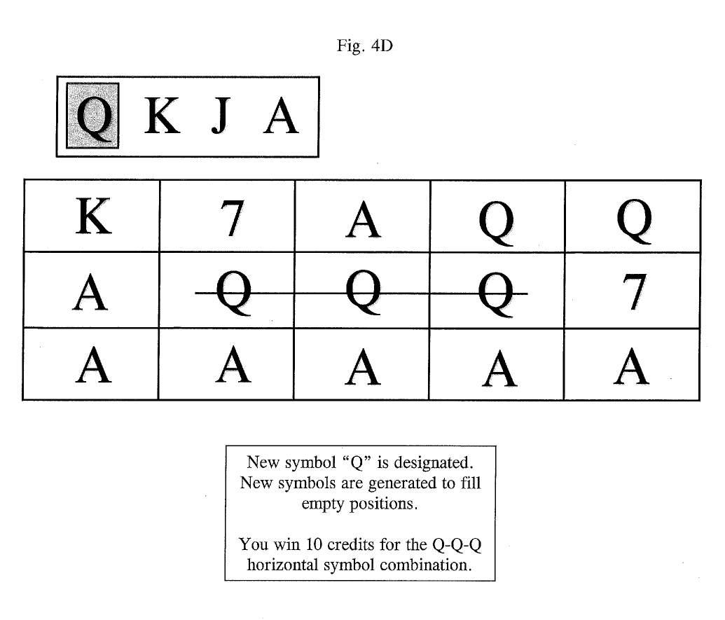

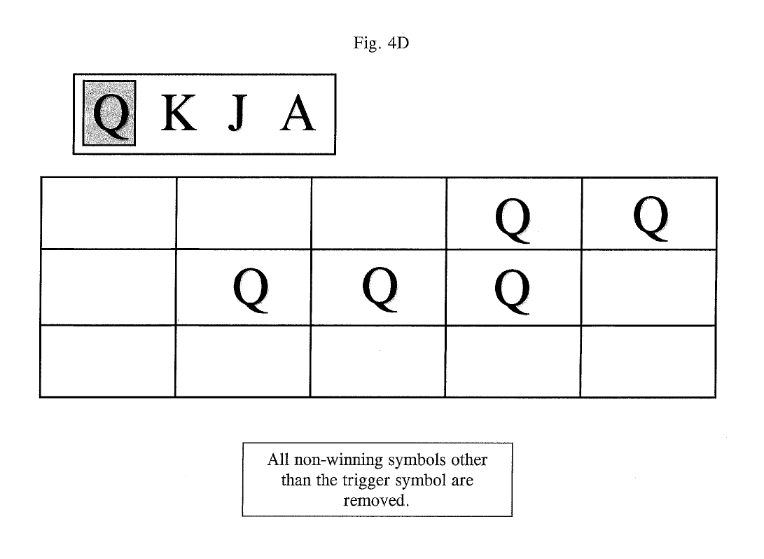

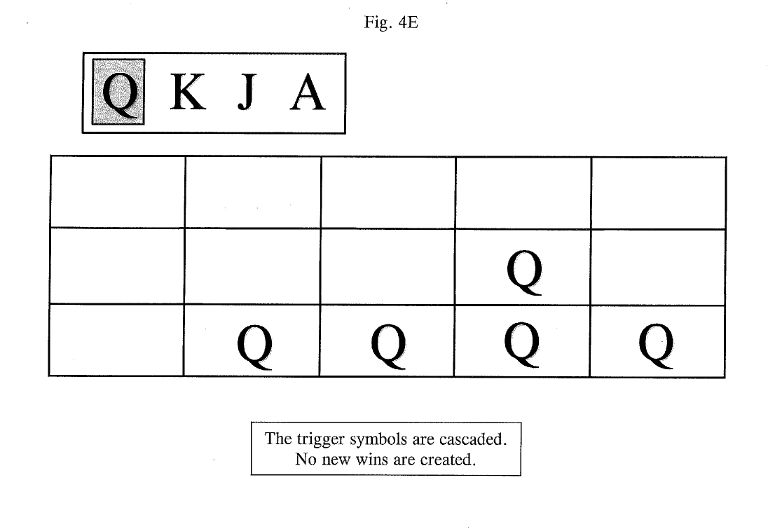

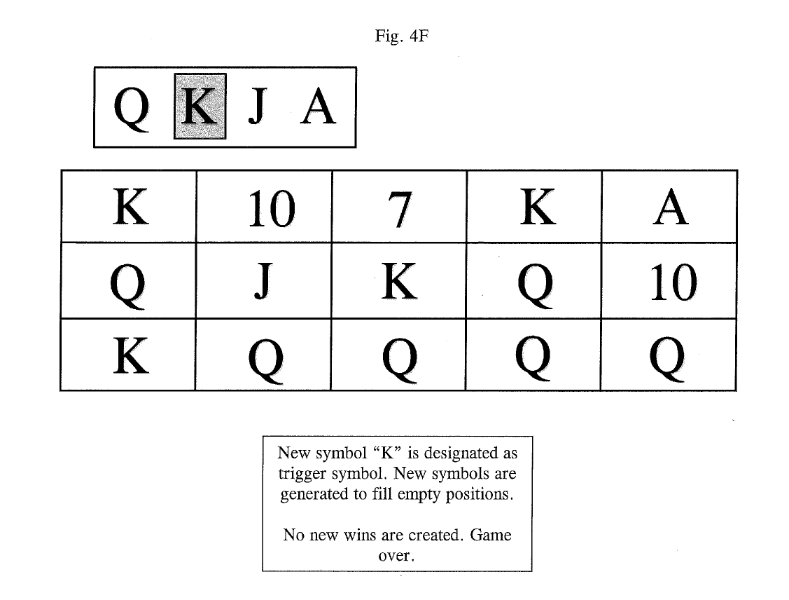

FIG. 4 illustrates an embodiment wherein the active symbol 430 within the designated symbol area 415 changes during the game. In this embodiment, the processor displays randomly generated symbols in the matrix 410. In an embodiment, the processor determines whether any winning symbol combinations have been created within the matrix 410. In this embodiment, a winning symbol combination 420 has been created—three (3) “A”s in a diagonal pattern. In an embodiment, the win associated with the winning symbol combination 420 is displayed and/or awarded to the player. Because there was a winning symbol combination, the processor then, in this embodiment, determines whether the winning symbol combination 420 corresponds with the active symbol 430 within the designated symbol area 415. In this case, there is correspondence. Because the active symbol 430 within the designated symbol area 415 is an “A” and the winning symbol combination 420 involves “A”s, the game continues.

The gaming system then determines, in this embodiment, whether any of the displayed symbols qualify to be removed. If one or more of the displayed symbols qualify to be removed, the gaming system removes such displayed symbols, leaving empty symbol positions 425, shown in FIG. 4B. Because the active symbol 430 was an “A” and the winning symbol combination 420 involved an “A”, all symbols other than the “A”s are removed from the matrix 410 in this embodiment. The remaining displayed symbols 435 then cascade, in this example, downward. FIG. 4C illustrates the remaining displayed symbols 435 after their cascade, each moving to any empty symbol positions 425 below their previous symbol position. Note that in an embodiment, the first cascade could be a downward cascade and the second cascade could be a right-to-left cascade or an upward cascade. Any combination of directional cascade could be utilized. In an embodiment, the processor may then determine whether any winning symbol combinations have been created within the matrix symbols due to the cascade. As shown in FIG. 4C, a new horizontal A-A-A-A-A winning symbol combination 475 has been formed. In an embodiment, the win associated with the winning symbol combination 475 is displayed and/or awarded to the player.

In an embodiment, new symbols are then generated to fill the empty symbol display positions 425. FIG. 4D illustrates the matrix 410 as filled with newly generated symbols 480, each of which fills a previously empty symbol display position 425. In this embodiment, however, the active symbol 430 within the designated symbol area 415 may also change. This may occur before, after, or simultaneous with the generation of new symbols 480. In the example shown in FIG. 4D, the active symbol 430 is now a “Q”.

In an embodiment, the processor may then determine whether any winning symbol combinations have been created within the matrix 410 after the generation of the new symbols 480. In the embodiment shown in FIG. 4D, a new winning symbol combination 485 is shown as a horizontal Q-Q-Q. In an embodiment, the win associated with the winning symbol combination 485 is displayed and/or awarded to the player.

Because there was a winning symbol combination 485, the processor then, in this embodiment, determines whether the winning symbol combination 485 corresponds with the active symbol 430 within the designated symbol area 415. In this case, there is correspondence. Because the active symbol 430 within the designated symbol area 415 is an “Q” and the winning symbol combination 485 involves “Q”s, the game continues.

The gaming system then determines, in this embodiment, whether any of the displayed symbols qualify to be removed. If one or more of the displayed symbols qualify to be removed, the gaming system removes such displayed symbols, leaving empty symbol positions 490, shown in FIG. 4D. Because the active symbol 430 was a “Q” and the winning symbol combination 485 involved a “Q”, all symbols other than the “Q”s are removed from the matrix 410 in this embodiment. Note that even though the “A”s were previously retained because the active symbol 430 was an “A”, because the active symbol 430 is no longer an “A”, the “A”s are no longer retained. Only “Q”s, in this embodiment, are retained.

The remaining displayed symbols 495 then cascade, in this example, downward. FIG. 4E illustrates the remaining displayed symbols 495 after their cascade, each moving to any empty symbol positions 490, where one exists, below their previous symbol position. In an embodiment, the processor may then determine whether any winning symbol combinations have been created within the matrix 410 symbols due to the cascade. As shown in FIG. 4E, no new winning symbol combinations have been formed.

In an embodiment, new symbols are then generated to fill the empty symbol display positions 490. FIG. 4F illustrates the matrix 410 as filled with newly generated symbols, each of which fills a previously empty symbol display position 490. In this embodiment, the active symbol 430 within the designated symbol area 415 may again change. This may occur before, after, or simultaneous with the generation of new symbols. In the example shown in FIG. 4F, the active symbol 430 is now a “K”.

In an embodiment, the processor may then determine whether any winning symbol combinations have been created within the matrix 410 after the generation of the new symbols. In the embodiment shown in FIG. 4F, no new winning symbol combinations have been created. Accordingly, this game is over. The processor awaits a request for initiation of a new game.

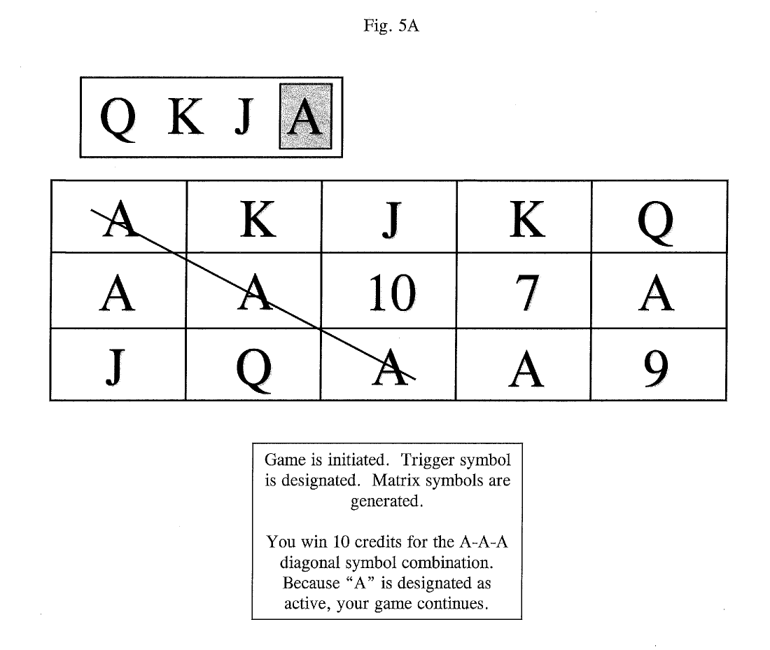

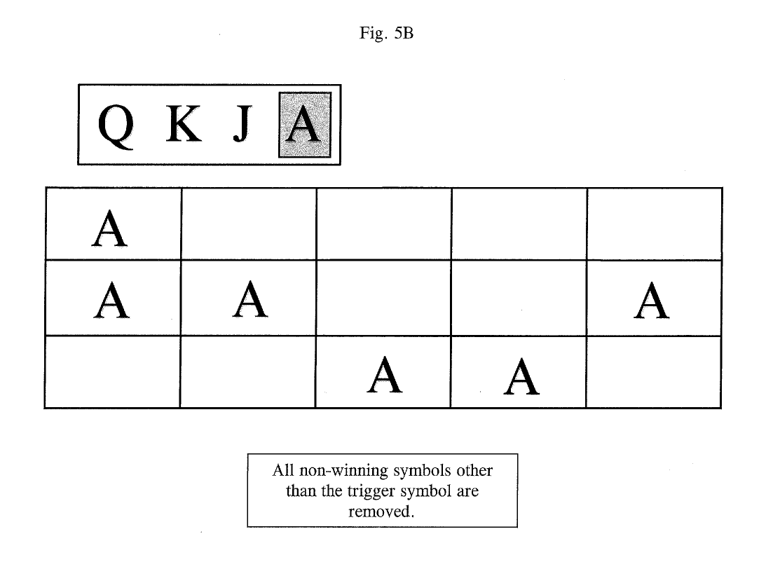

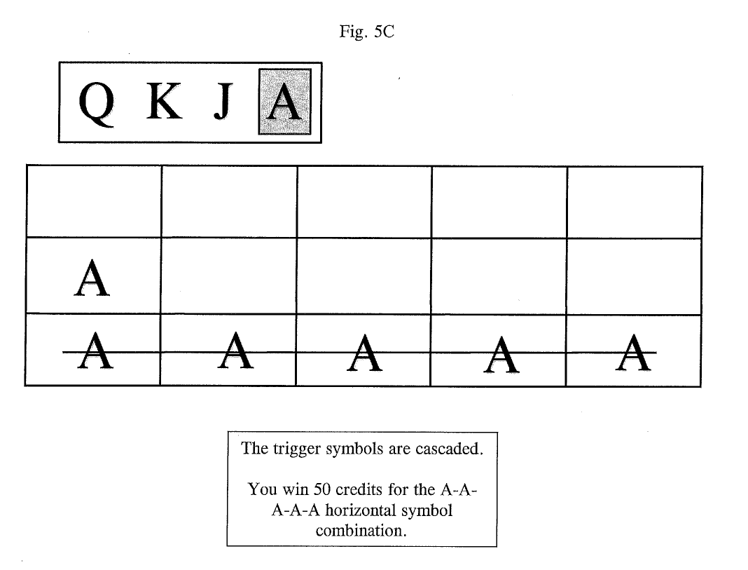

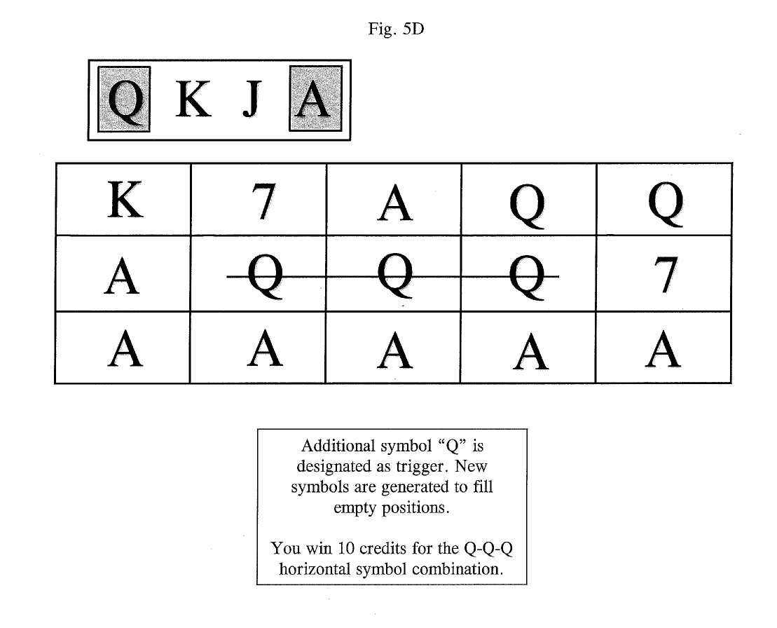

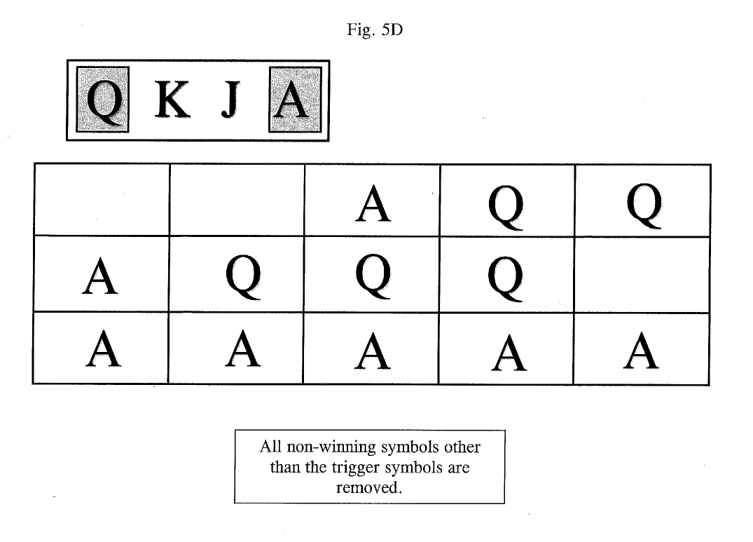

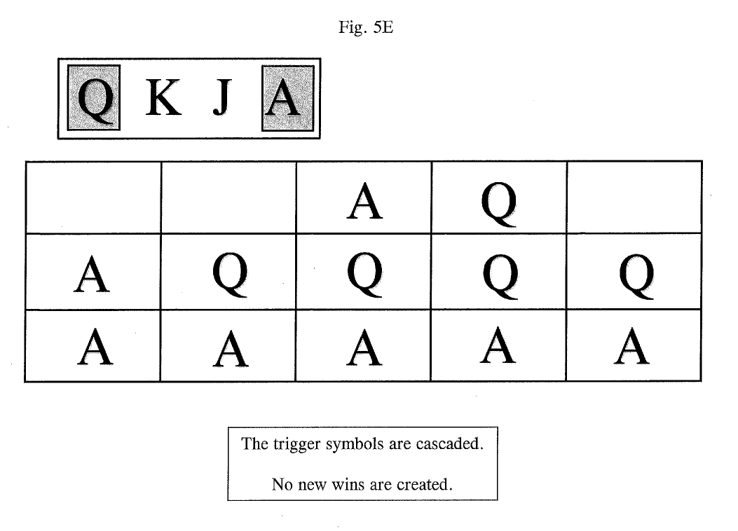

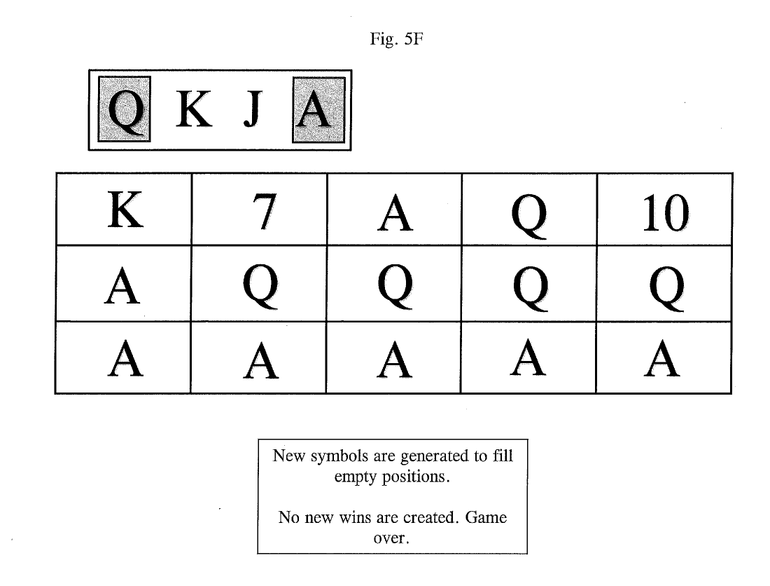

FIG. 5 illustrates an embodiment wherein more than one active symbol 530 within the designated symbol area 515 is simultaneously active during the game. In this embodiment, the processor displays randomly generated symbols in the matrix 510. In an embodiment, the processor determines whether any winning symbol combinations have been created within the matrix 510. In this embodiment, a winning symbol combination 520 has been created—three (3) “A”s in a diagonal pattern. In an embodiment, the win associated with the winning symbol combination 520 is displayed and/or awarded to the player. Because there was a winning symbol combination, the processor then, in this embodiment, determines whether the winning symbol combination 520 corresponds with the active symbol 530 within the designated symbol area 515. In this case, there is correspondence. Because the active symbol 530 within the designated symbol area 515 is an “A” and the winning symbol combination 520 involves “A”s, the game continues.

The gaming system then determines, in this embodiment, whether any of the displayed symbols qualify to be removed. If one or more of the displayed symbols qualify to be removed, the gaming system removes such displayed symbols, leaving empty symbol positions 525, shown in FIG. 5B. Because the active symbol 530 was an “A” and the winning symbol combination 520 involved an “A”, all symbols other than the “A”s are removed from the matrix 510 in this embodiment. The remaining displayed symbols 535 then cascade, in this example, downward. FIG. 5C illustrates the remaining displayed symbols 535 after their cascade, each moving to any empty symbol positions 525 below their previous symbol position. In an embodiment, the processor may then determine whether any winning symbol combinations have been created within the matrix symbols due to the cascade. As shown in FIG. 5C, a new horizontal A-A-A-A-A winning symbol combination 575 has been formed. In an embodiment, the win associated with the winning symbol combination 575 is displayed and/or awarded to the player.

In an embodiment, new symbols are then generated to fill the empty symbol display positions 525. FIG. 5D illustrates the matrix 510 as filled with newly generated symbols 580, each of which fills a previously empty symbol display position 525. In this embodiment, however, an additional symbol within the designated symbol area 515 may become an active symbol 530. This may occur before, after, or simultaneous with the generation of new symbols 580. In the example shown in FIG. 5D, the active symbols 530 include both a “Q” and an “A”.

In an embodiment, the processor may then determine whether any winning symbol combinations have been created within the matrix 510 after the generation of the new symbols 580. In the embodiment shown in FIG. 5D, a new winning symbol combination 585 is shown as a horizontal Q-Q-Q. In an embodiment, the win associated with the winning symbol combination 585 is displayed and/or awarded to the player.

Because there was a winning symbol combination 585, the processor then, in this embodiment, determines whether the winning symbol combination 585 corresponds with at least one active symbol 530 within the designated symbol area 515. In this case, there is correspondence. Because one of the active symbols 530 within the designated symbol area 515 is an “Q” and the winning symbol combination 585 involves “Q”s, the game continues.

The gaming system then determines, in this embodiment, whether any of the displayed symbols qualify to be removed. If one or more of the displayed symbols qualify to be removed, the gaming system removes such displayed symbols, leaving empty symbol positions 590, shown in FIG. 5D. Because one of the active symbols 530 was a “Q” and the winning symbol combination 585 involved a “Q”, all symbols other than the active symbols 430 (i.e. the “Q”s and the “A”s) are removed from the matrix 510 in this embodiment. Note that in an embodiment, the “A”s could have been removed from the matrix 510 because no “A” was involved with the winning symbol combination 585. Either possibility is contemplated by the invention.

The remaining displayed symbols 595 then cascade, in this example, downward. FIG. 5E illustrates the remaining displayed symbols 595 after their cascade, each moving to any empty symbol positions 590, where one exists, below their previous symbol position. In an embodiment, the processor may then determine whether any winning symbol combinations have been created within the matrix 510 symbols due to the cascade. As shown in FIG. 5E, no new winning symbol combinations have been formed.

In an embodiment, new symbols are then generated to fill the empty symbol display positions 590. FIG. 5F illustrates the matrix 510 as filled with newly generated symbols, each of which fills a previously empty symbol display position 590. In this embodiment, the active symbols 530 within the designated symbol area 515 may again change or may not change. One symbol may become deactivated, different symbols may become activated, or the symbol activation could remain the same. Any configuration is contemplated as part of the invention. This may occur before, after, or simultaneous with the generation of new symbols. In the example shown in FIG. 5F, the active symbols 530 are still a “Q” and an “A”.

In an embodiment, the processor may then determine whether any new winning symbol combinations have been created within the matrix 510 after the generation of the new symbols. In the embodiment shown in FIG. 5F, no new winning symbol combinations have been created. Accordingly, this game is over. The processor awaits a request for initiation of a new game. If winning symbol combinations had been created, the process would repeat.

In an embodiment, if any “wild” or “bonus” symbols are generated and displayed in the matrix, those wild or bonus symbols may be locked in position or may be cascaded as described herein. In a particular embodiment, this wild feature may be in addition to the locking and/or cascading of the trigger symbol. In an embodiment, the active or trigger symbol is re-designated for each new game. In a separate embodiment, the active or trigger symbol is re-designated for each new cascade within a single game.

In an embodiment of the invention, more than one designated symbol area is provided. In this embodiment, a second or additional designated symbol area could become activated with a higher bet level, or could become active after multiple cascades. For example, if at least two cascades are triggered in a single game, a second designated symbol area may become activated and/or visible to the participant. The second or additional designated symbol area may operate in the same manner as the first designated symbol area 115, as described herein, or may provide different features.

In still another embodiment, multiple cascades may activate a secondary or bonus game that operates similarly to the game features described herein. For example, in this embodiment, if more than one cascade is triggered within a single game, a bonus game may be triggered. In this embodiment, the bonus game may have a separate designated symbol area where it designates a separate active symbol. Similarly, the bonus game may treat the active designated symbol from the base game as the active designated symbol for the bonus rounds. In this example, one or more bonus games may be provided to the player and one or more designated symbols may be locked in place and/or cascade as described herein for each of those bonus games. For example, a base game may have three (3) cascades which occur, triggering a bonus game. In the bonus game, the active designated symbol from the base game (a “J”, for example) may continue as active during the bonus games. In this example, any “J” symbols that appear during bonus games may be locked in place or may remain and cascade as described herein. Alternatively, any “J” symbols that are involved in a bonus game win may be locked in place or may remain and cascade as described herein. In contrast to the base games, the designated symbol may continue to be active from game to game during the bonus round.

In still another embodiment, a game win or a cascade could trigger the activation of a multiplier within the game. For example, if the player wins a first game or triggers a cascade during the first game, a 2× multiplier could be activated for the next consecutive game. If the player wins the second game or triggers a cascade during the second game, a 3× multiplier could be activated for the next consecutive game. This process could repeat until a certain level of multiplier is reached or until the player participates in a game that he does not win or does not trigger a cascade. At that point, the multiplier may restart at zero, may remain locked at the current level, or may be stepped down to a multiplier level which is less than the current level. In another embodiment, the multiplier may be triggered by an event that is entirely separate from the cascade effect described herein. The multiplier may be visually displayed to the player in an area of the game display screen.

In an embodiment, a visual display of the number of consecutively won games or the number of consecutive games in which a cascade was initiated may be visually displayed onscreen as a tally.

In another embodiment, the processor may trigger duplicating reel sets under certain circumstances. For example, if the player wins a certain number of games or if the player triggers cascade effects in a certain number of games (as optionally indicated by an onscreen tally), a second reel may appear onscreen. The second reel set may have the same or different symbols displayed it its matrix. In an embodiment, the second reel set is a duplicate of the first reel set, but once the reels begin to spin, they may generate different symbols in different positions or may start and stop at different times, increasing the possible number of wins. The number of reel sets may progressively increase based upon the number of consecutively won games, the number of cascade effects triggered, or any other trigger. For example, in game 1, one reel set may be displayed. If the player triggers a cascade, in game two, two reel sets may be displayed. If the player triggers a cascade in game two, in game three, three reel sets may be displayed. In an embodiment, up to eight (8) or more reel sets may be displayed. With each additional reel set, the number of win possibilities increases. The reel sets may be displayed above or below each other, side-by-side, in a grid format, circular format, or in any configuration known. Each reel set may spin and display symbols independently of the others, in an embodiment. Each reel set may have the cascading feature as described herein, each operating separately from the others. The number of reel sets displayed may reset to one when the player loses a game or does not trigger a cascade during a game.

In still another embodiment, the processor may trigger additional reels or rows added to the matrix 110 under certain circumstances. For example, if the player wins a certain number of games or if the player triggers cascade effects in a certain number of games (as optionally indicated by an onscreen tally), an additional reel may appear onscreen for the following game. The number of reels may continue to increase for consecutive wins or cascade triggers. For example, in game 1, five reels may be displayed. If the player triggers a cascade, in game two, six reels may be displayed. If the player triggers a cascade in game two, in game three, seven reels may be displayed. With each additional reel displayed, the number of win possibilities increases. Similarly, the number of rows could increase based upon similar triggers. In an embodiment, the number of rows and the number of columns each increase based upon various triggers. The number of rows and columns may reset to their original configuration if the player loses a game or does not trigger a cascade effect in the game.

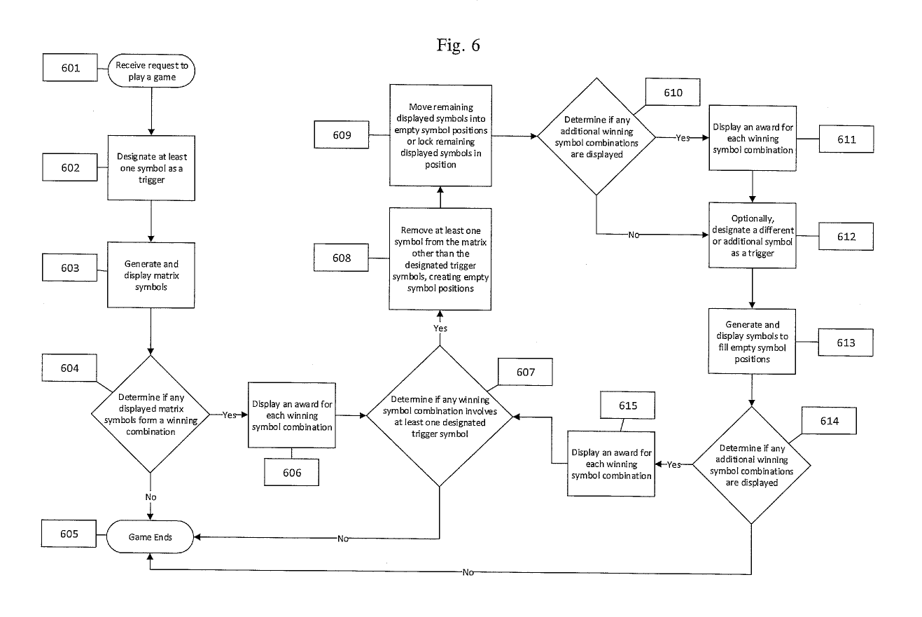

Referring now to FIG. 6, a method for implementation of the invention is set forth in a flow chart. In this embodiment, the processor receives a request to play a game at step 601. This would typically involve a player approaching a gaming device and inserting money, a card, a receipt, or the like. Similarly, this may involve the player logging into a terminal. Similarly, this may simply involve a participant pressing a “start,” “spin,” “reveal,” or other game initiation button (mechanical or digital). At step 602, the processor designates at least one symbol as a trigger symbol. At step 603, the processor generates and displays a plurality of matrix symbols.

The processor, at step 604, then determines if any displayed matrix symbols form a winning symbol combination. If no, the game ends 605 and the processor awaits a new request to play a game. If yes, the processor may then display and/or award a prize to the participant for each winning symbol combination at step 606. The processor then determines, at step 607, if any of the winning symbol combinations involves at least one of the designated trigger symbols (also referred to herein as “active” symbols). If no, the game ends 605 and the processor awaits a new request to play a game. If yes, in an embodiment, the processor removes at least one symbol from the matrix other than the matrix symbols which are the same as the designated symbol (step 608). In some embodiments, the symbols that remain after removal may include only the symbols that are involved in the winning symbol combination. In other embodiments, the symbols that remain after removal may include all of the displayed matrix symbols that are the same as the designated trigger symbol. At step 609, the processor may then either lock the remaining displayed symbols in place or move or “cascade” those symbols to empty symbol positions. At step 610, if the processor cascaded the remaining symbols, the processor may then determine if any additional winning symbol combinations are displayed. If yes, the processor may then award and/or display a prize to the participant for each winning symbol combination (step 611) and may then proceed to step 612. If no additional winning symbol combination was displayed at step 610, the system may move directly to step 612.

At step 612, the processor may optionally designate a different or additional trigger symbol. Alternatively, step 612 may be skipped and the process may proceed to step 613 using the same designated symbol that was set forth in step 602. At step 613, the processor generates and displays new or replacement symbols to fill the empty symbol positions that were created in step 608. The system then proceeds to step 614, where the processor determines if any additional winning symbol combinations are displayed. If no, the game ends (step 605). If yes, the processor displays and/or awards a prize to the participant for the winning symbol combination(s) (step 615) and then proceeds to step 607. The process repeats until the game ends at step 605. At or near the completion of the game, the system and device may be configured to allocate prizes to an account associated with the participant or directly pay the participant from the machine.

Advantageously, the inventive system, device and game provides a novel and stimulating variation on the basic reel-based slot game and even the standard cascading reel games, yet complies with the strict regulatory restrictions set forth for the gaming industry. In the present invention, the cascading and/or locking effects provide a new layer of excitement to the player. When the player sees a particular symbol locked in place as the reel spins and sees matching symbols passing through the matrix, the player thinks there is a higher likelihood of a potential win and becomes excited. As the symbols are generated or move into place, the player waits with anticipation to see if any symbols will match up, be positioned along the various paylines, or will fall into various other winning combinations. This provides a significantly higher level of player excitement because it provides a greater expectation of winning.

Further, removing the non-winning symbols and cascading the winning symbols, in contrast to the standard method of cascading symbols, provides an additional opportunity to win. In the standard method, the winning symbols are removed and the non-winning symbols are cascaded. There is a potential to win an additional prize with the non-winning symbols after they are cascaded into the empty symbol positions, but the potential to win an additional prize with the winning symbols after they are cascaded into the empty symbol positions is much higher. For example, if the initial win is three diagonal “J”s, after those symbols cascade downward, the participant is likely to have an additional win for the same three “J”s in a horizontal payline. The same is not necessarily true if the non-winning symbols are cascaded. Thus, the present invention provides more opportunities for the participant to win a prize than the standard cascading game would.

Additionally, the inventive system is accompanied with new and more unusual features than traditional games offer. For example, existing cascading games initiate a cascade any time there is a win, not based upon a designated trigger. In addition, throughout a single game, the system of the present invention may retain matrix symbols that correspond with the trigger symbol, regardless if they are involved with the winning symbol combination. Furthermore, the system of the present invention may designate multiple trigger symbols or may change the trigger symbols during play of a single game. Each of these features, as well as other features, are novel and unique to the present invention.

In an embodiment, the matrix symbols can be selected, generated, and/or displayed by in various ways. In one embodiment, for example, reel strips can be used to select, generate, and/or display reel symbols. In this embodiment, a first reel strip may be selected for a first reel (which may be any reel within the matrix). The reel strip may be randomly selected in an embodiment, using any method known in the art, such as via use of a random number generator. Alternatively, the system may direct the reels strip to be selected in a particular order. In yet another embodiment, the reel strips may be randomized ahead of a game and may be selected in order.

Similarly, additional reel strips may be selected for additional reels. In an embodiment, after at least one reel strip is selected and displayed (or simultaneous with the selection and/or display thereof) for at least one reel or for each reel, one or more of the reels may spin. The reels may stop randomly, stop in a predetermined position, or may be stopped manually by the participant. If a winning combination of symbols is displayed (and/or obtained through some exercise of skill by the participant), the participant may win a prize. The winning combination may be determined based upon symbols (matching or otherwise) lining up along a predetermined payline, appearing in predetermined matrix positions, or using any other method known in the art. At the end of each game, wins may be calculated. Any payline known in the art may be utilized to calculate wins. Wins may be calculated left-to-right or right-to-left. Similarly, any scatter pattern (or other known win methodology) known in the art could be used to calculate wins. Wild or bonus symbols may be utilized within and throughout the game to increase excitement and calculate wins.

In an embodiment, each of the reel strips is selected from a database of reel strips. The database may contain any number of reel strips. In an embodiment, some reel strips may be related. For example, there may be a particular set of reel strips available for reel 1, a different set of reel strips available for reel 2, and yet a different set of reel strips available for reel 3. Alternatively, the reel strip for each reel may be selected from a common pool of reel strips.

Each pool or set of reel strips may contain any number of reel strips. In an embodiment, the processor selects reel strips from the database prior to each game to determine the reel strip that will displayed for each reel. This selection may be random or predetermined. In an embodiment, the system may first randomly select a reel strip for reel 1, then randomly select a reel strip for reel 2, and then randomly select a reel strip for reel 3 (or in any other order known). These selections may occur nearly simultaneously. Alternatively, the processor may select reel strips for all available reels simultaneously. Similarly, the reel strips may be displayed within the reel positions in any order known in the art or may be displayed simultaneously.

In an embodiment, the database may contain a set of reel strips that are associated with multiple reels. For example, set “ABC” of reel strips may contain a particular reel strip for reel 1, a particular reel strip for reel 2, and a particular reel strip for reel 3. In this embodiment, the processor may separately (randomly or predeterminedly) select each reel strip within the set or may selected set ABC itself and thereby display the particular reel strip associated with each reel within the set.

Each reel strip may contain any number of symbol positions, each configured to display a symbol. For example, each reel strip may contain 20, 30, 50, or 100 (or any other number) symbol positions. In an embodiment of the invention, each reel strip has a finite and/or predetermined number of symbol positions. In another embodiment, the number of symbol positions in each reel strip varies. In a particular embodiment, the number of symbol positions in each reel strip is randomly determined for each game or for a set of games.

In an embodiment, the processor consults a weighted table to determine the combination of reel strips (the “reel strip combination”) that will be selected for a particular game. In this embodiment, there may be a finite number of reel strips and/or reel strip combinations, each having an associated weight. For example, if a game has 5 reels and 11 reel strips per reel (55 total reel strips), there may be 161,051 possible reel strip combinations. Each reel strip combination may be associated with a letter, number, or other indicia, or a set of letters, numbers, or other indicia. For example, a set of 5 numbers may be associated with each reel strip combination for a system having 5 reels. In an embodiment, each reel strip combination has more than one associated weight. In this embodiment, one of the weights may be associated with a base game and one or more weights may be associated with a bonus game.

In an embodiment, the table may be indexed to indicate which reel strip should be selected for each reel. For example, the table may be indexed so that 3/8 indicates that reel strip 8 should be selected for reel 3. In an embodiment, each of the reel strips is unique. For example, reel strip 3 for reel 1 may be different from reel strip 3 for reel 2. With reference to Table 1, the table may be indexed as indicated. In this example, if the processor selects Index #2847 from Table 1, reel 1 will be populated with reel strip 3, reel 2 will be populated with reel strip 1, reel 3 will be populated with reel strip 4, reel 4 will be populated with reel strip 9, and reel 5 will be populated with reel strip 7. Index #2847 may be indicated as 1(reel)/3(associated reel strip), 2/1, 3/4, 4/9, 5/7.

TABLE 1

| Index # | Reel 1 | Reel 2 | Reel 3 | Reel 4 | Reel 5 |
|---|---|---|---|---|---|
| 0001 | 1 | 1 | 1 | 1 | 1 |
| 0002 | 2 | 1 | 1 | 1 | 1 |
| 2847 | 3 | 1 | 4 | 9 | 7 |
| 2848 | 3 | 1 | 4 | 9 | 8 |

In an embodiment, the table additionally comprises one or more subsets of indices. For example, the table could be configured such that if, in game one, Index #0001 is selected, only a subset of the 161,051 possible reel strip combinations would be available in game 2. Similarly, once the Index # is determined for game 2, only a subset of the possible combinations that were available in the second game would be available in game 3. This process may repeat for a defined period of time, defined number of games, or until a defined number of combinations is available, before resetting and making all available combinations available once again.

In another embodiment, multiple weighted tables may be utilized. In this embodiment, in game one, Index #0001 may be selected from Table 1. The processor may then be required to select an index # from a separate table for game 2. Similarly, the processor may be required, for game 3, to select an index # from a third table. Each of the tables may be unique. Again, this process may repeat for a defined period of time, defined number of games, or until a defined number of combinations is available, before referring back to Table 1 and repeating the process. Similarly, separate tables may be utilized for a base game and one or more a bonus games.

In another embodiment, reel strips are not utilized and symbols may be individually randomly generated for each displayed symbol position. In this embodiment, a random number generator may be utilized to determine which symbols will be displayed in which positions. In yet another embodiment, each reel position comprises just one long reel strip and reel strips are not selected for each game.

As will be appreciated by one skilled in the relevant field, the present invention may be, for example, embodied as a computer or gaming system, a method, or a computer or gaming program product. Furthermore, particular embodiments may take the form of a computer or gaming program product stored on a computer-readable storage medium having computer-readable instructions (e.g., software) embodied in the storage medium. Various embodiments include web-implemented computer software. Examples of suitable computer-readable storage medium may include, for example, hard disks, compact disks, DVDs, optical storage devices, and/or magnetic storage devices.

The computer program instructions may be loaded onto and executed on a gaming device, a gaming server, a gaming machine, a general purpose computer, a special purpose computer, smart mobile device, or other programmable data processing apparatus to produce a machine. The computer program instructions may be stored in a computer-readable memory that can direct a computer or other programmable data processing apparatus to function in a particular manner such that the instructions stored in the computer-readable memory produce an article of manufacture that is configured for implementing the functions described herein. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified herein.

The inventive system may be a linked system. In this embodiment, a plurality of gaming machines may be arranged side-by-side, near one another, in a particular area, or spread out. In an embodiment, a common jackpot prize display may be viewable from each gaming machine. Each gaming machine may have a display unit. Each of the gaming machines may be electronically linked to one another and, optionally, a jackpot prize display through a control module. A win of the jackpot prize may be triggered by specific outcomes. Players may be made aware of a jackpot award by means of the common display. It will be appreciated that the linked machines may form part of Local Area Networks (LAN) or Wide Area Networks (WAN).

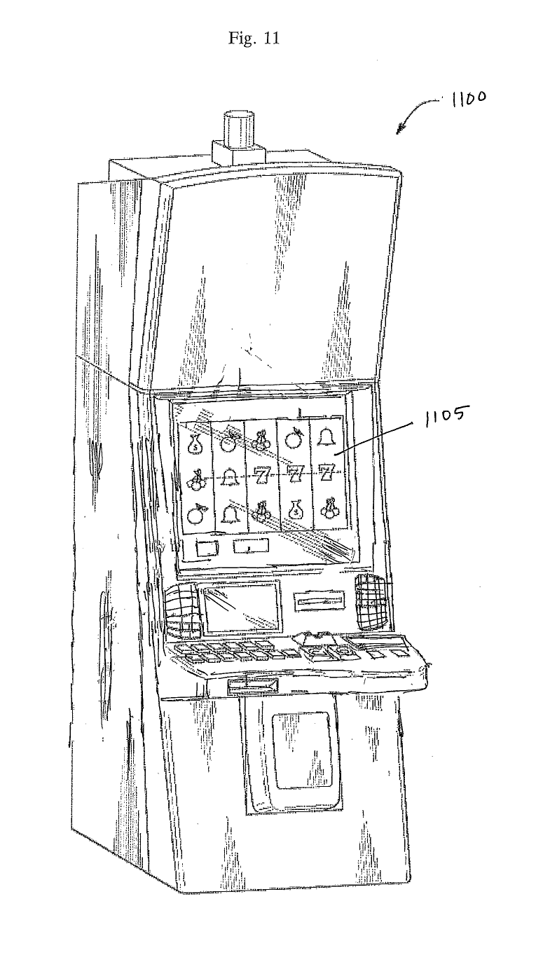

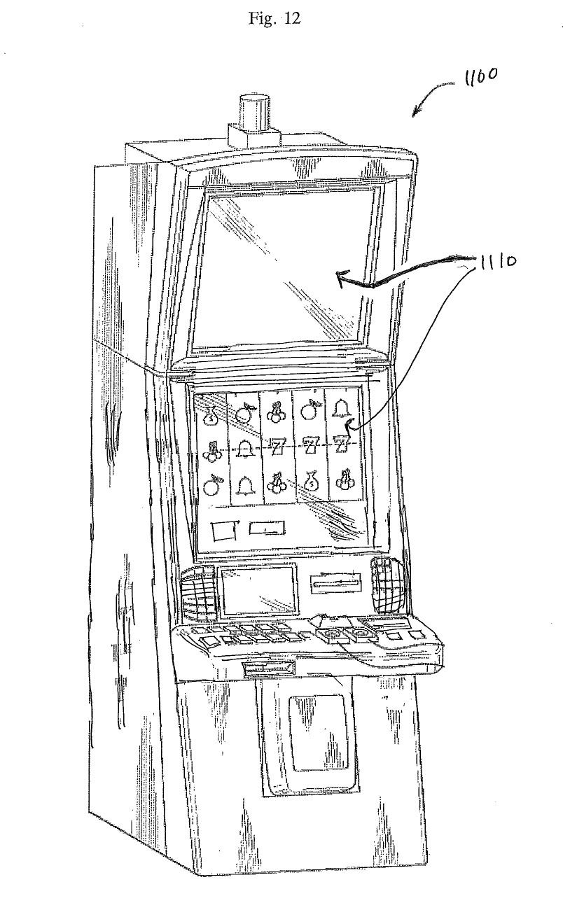

In another embodiment, the inventive system may be operable in a standalone capacity, on a gaming machine 1100 (FIGS. 11-12). The gaming machine 1100 may have a single display panel 1105, double display panel 1110, or may comprise any other configuration known in the art.

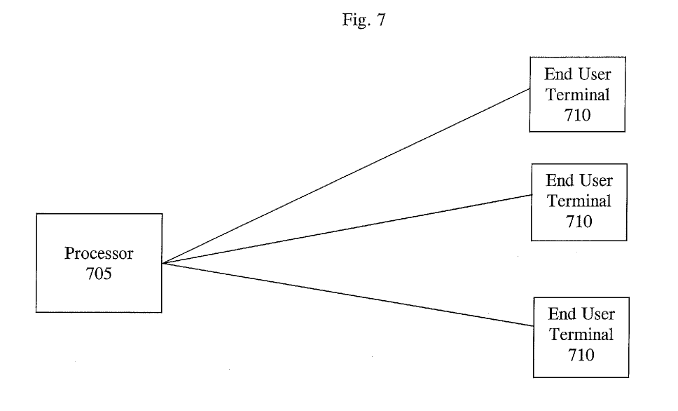

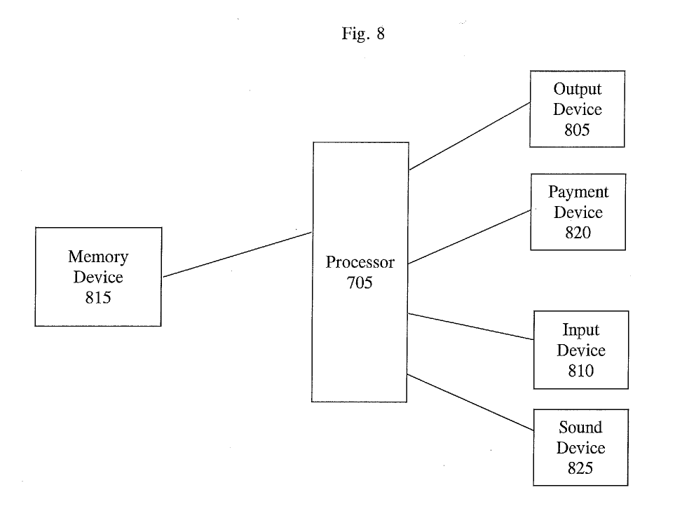

FIG. 7 illustrates an embodiment of a block diagram of the inventive system, illustrating communications between the processor 705 and multiple end user terminals 710. Similarly, FIG. 8 illustrates an embodiment of a block diagram of the inventive system, illustrating communications between the processor 705 and a memory device 815, an output device 805, an input device 810, a payment device 820, and a sound device 825.

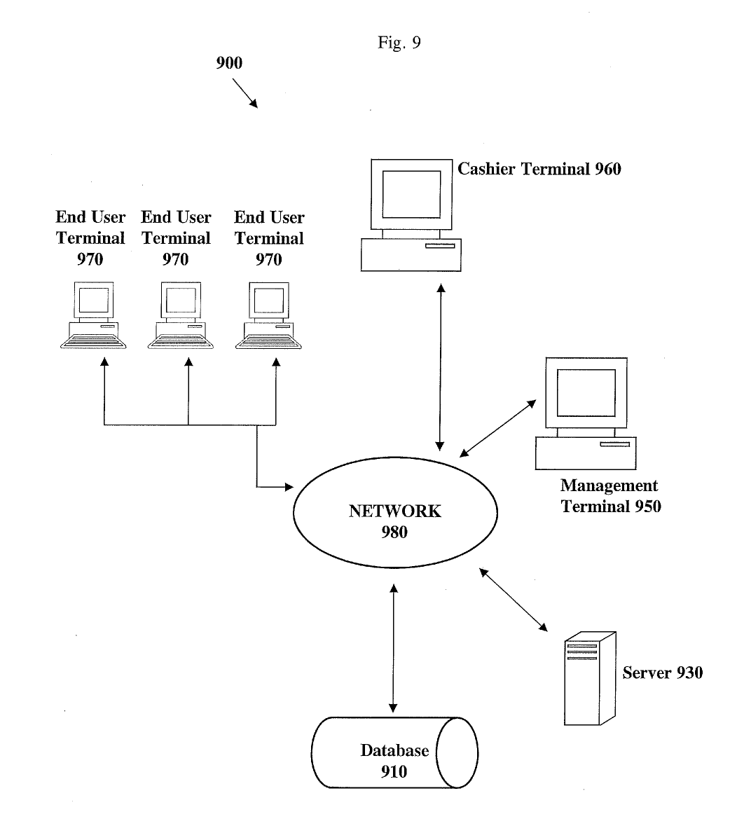

By way of the example shown in FIG. 9, in an embodiment, the inventive system may comprise a network 980, a database 910, at least one server 930, optionally, at least one management terminal 950, optionally, at least one cashier terminal (also known as a point-of-sale terminal or POS terminal) 960, and one or more end user terminals 970, or any combination thereof. Those skilled in the art with reference to this disclosure should appreciate that other configurations may be used to accomplish the methods described herein without departing from the scope of the present invention. For example, in various embodiments, the cashier terminal 960 and the end user terminals 970 may comprise the same device.

It should be understood that each of the computing devices, including the server 930, the management terminal 950, the POS terminal 960, and the one or more end user terminals 970 may each have a computer hardware processor, input and output devices (for example, a computer monitor, a keyboard, selection buttons, and/or mouse) and at least one storage device (for example, memory, hard drives, etc.). These devices may also have network connection cards to connect to the network. At least some of these devices may also include a computer readable medium, which is further described herein.

The server 930 may be configured to communicate data to and from various devices in the system and to perform one or more method steps, as detailed below. The database 910 may contain various types of data and computer instructions for performing at least some of the steps presented herein. It should be understood that the network 980 may be comprised of multiple servers 930 and multiple databases 910, whether located locally and networked through a LAN or remotely through a WAN or an Intranet connection. The end user terminals 970 may be linked together via a network. Each end user terminal 970 may be a standalone gaming device, a kiosk, a personal computer (PC), a smart phone, a tablet, or other computing device.

The POS terminal 960 and/or the end user terminals 970 may allow a user to purchase game plays. In some embodiments, a user account card may be issued by the POS terminal 960, which contains an electronic account detailing user account information. The user account card may be used at the end user terminals 970 to participate in the games described herein.

A POS terminal 960 (through a cashier or directly) may provide the user with a receipt containing a code (such as a 16-digit hexadecimal code), a PIN, or a username/password that the user may then use for accessing the system or to access his/her account on an end user terminal 970. In an online embodiment, the user may access the inventive system through a browser interface that may provide a similar code to the user after account creation. This code may provide access to the software and/or specifically to the customer's account on the software.

In various embodiments, the system may allow a user to deposit currency into an end user terminal 970 or gaming machine 1100 through a credit card reader, currency/bill acceptor, or other device as is known in the art. The management terminal 950 may be a device that is operatively connected with the POS terminal 960, end user terminals 970, and/or server 930 to run cashier reports, calculate revenues and costs, track purchases of games, track prizes awarded, and/or review other game data. Other managerial or supervisory operations may also be performed using the management terminal 950. The server 930 may control one or more operations of the game system, as discussed herein.

One or more of the devices illustrated in FIG. 9 may be connected to network 980 as previously mentioned. In one embodiment, all devices in FIG. 9 are connected to the network 980 and communicate with each other over the network 980. It should be noted that the network 980 in FIG. 1 need not be a single network (such as only the internet) and may be multiple networks (whether connected to each other or not). In another embodiment, the network may be a LAN and a WAN (e.g., the Internet) such that one or more devices (for example, server 930, management terminal 950 and database 910) are connected together via the LAN, and the LAN is connected to the WAN which in turn is connected to other devices (for example, end user terminals 970). The terms “linked together” or “connected together” refers to devices having a common network connection via a network (either directly on a network or indirectly through multiple networks), such as one or more devices on the same LAN, WAN or some network combination thereof. It should be understood that FIG. 9 is an exemplary embodiment of the present system and various other configurations are within the scope of the present system. For example, one or more of the management terminal 950, point of sale terminal 960, and end user terminals 970 may all be located in one location and server 930 may be located in another location, where all of these system components are operatively coupled by a network such as the Internet. Additionally, it should be understood that additional devices may be included in the system shown in FIG. 9 and some devices shown in FIG. 9 may be omitted from a particular inventive system, such as, by way of example, the point of sale terminal 960. In other embodiments, certain devices may perform the operation of other devices shown in the figure.

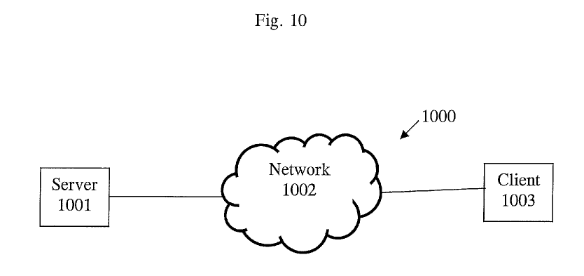

In an embodiment, the inventive system may be available to customers online, via the internet. As shown in FIG. 10, in an embodiment, the system 1000 includes a client device 1003 that is connected to a server 1001 via a network 1002. A participant may use the client device 1003 to access the game functionality, which is hosted on the server 1001. In an embodiment, the game functionality is implemented electronically by software that runs on the server 1001. The client device 1003 may comprise any type of computing device, as discussed herein.

For purposes of this disclosure, reference to a server or processor, shall be interpreted to include: a single server, a single processor; multiple servers; multiple processors; or any combination of servers and processors. In particular embodiments of the invention, any of the end user terminal 970, the cashier terminal 960, the management terminal 950, and the server 930 may be a computer. The computer may be connected (e.g., networked) to other computers by a LAN, an intranet, an extranet, and/or the Internet. The computer may operate in the capacity of a server or a client computer in a client-server network environment, or as a peer computer in a peer-to-peer (or distributed) network environment. The computer may be a PC, a tablet, a handheld device, a set-top box (STB), a Personal Digital Assistant (PDA), a web appliance, a server, or any computer capable of executing a set of instructions (sequential or otherwise) that specify actions to be taken by that computer. Further, the term “computer” may also include any collection of computers that individually or jointly execute a set (or multiple sets) of instructions to perform any one or more of the methodologies discussed herein.

In some embodiments, the computer architecture may include a processor, a main memory (e.g., read-only memory (ROM), flash memory, dynamic random access memory (DRAM) such as synchronous DRAM (SDRAM) or Rambus DRAM (RDRAM), etc.), a static memory (e.g., flash memory, static random access memory (SRAM), etc.), and a data storage device, which communicate with each other via a bus.

The processor may be a processing device such as a microprocessor, a central processing unit, or the like. More particularly, the processing device may be a complex instruction set computing (CISC) microprocessor, reduced instruction set computing (RISC) microprocessor, very long instruction word (VLIW) microprocessor, a processor implementing other instruction sets, or processors implementing a combination of instruction sets. The processor may also be one or more special-purpose processing devices such as an application specific integrated circuit (ASIC), a field programmable gate array (FPGA), a digital signal processor (DSP), a network processor, or the like. The processor may be configured to execute processing logic for performing various operations and steps discussed herein.

The computer architecture may further include a network interface device. The computer architecture also may include a video display (e.g., a liquid crystal display (LCD) or a cathode ray tube (CRT)), an alphanumeric input device (e.g., a keyboard), a cursor control device (e.g., a mouse), and a signal generation device (e.g., a speaker).

The data storage device may include a machine accessible storage medium (also known as a non-transitory computer-accessible storage medium, a non-transitory computer-readable storage medium, or a non-transitory computer-readable medium) on which is stored one or more sets of instructions embodying any one or more of the methodologies or functions described herein. The system may also reside, completely or at least partially, within the main memory and/or within processing device during execution thereof by a computer. The main memory and processing device also constitute computer-accessible storage media. Instructions may further be transmitted or received over a network via a network interface device.

While the machine-accessible storage medium may be a single medium, the term “machine-accessible storage medium” should be understood to include a single medium or multiple media (e.g., a centralized or distributed database, and/or associated caches and servers) that store the one or more sets of instructions. The term “machine-accessible storage medium” shall also be understood to include any medium that is capable of storing, encoding, or carrying a set of instructions for execution by the computer and that cause the computer to perform any one or more of the methodologies of the present invention. The term “computer-accessible storage medium” shall accordingly be understood to include, but not be limited to, solid-state memories, optical, and magnetic media. The game system that resides on server 930 may provide various functionalities as discussed herein. In various embodiments, the participant may access the inventive games through end user terminal 970.

In an embodiment, shown in FIG. 8 and as discussed in detail above, the processor 705 may communicate with a payment device 820, one or more input devices 810, one or more output or display devices 805, one or more sound devices 825, and a memory device 815. The payment device may comprise a note, ticket or bill acceptor, wherein the player inserts paper money, a ticket or voucher. The payment device may comprise a coin slot where the player inserts coins or tokens. In other embodiments, payment devices such as readers or validators for credit cards, debit cards or credit slips may accept payment. In one embodiment, a player may insert an identification card into a card reader of the gaming device. In one embodiment, the identification card is a smart card having a programmed microchip or a magnetic strip coded with a player's identification, credit totals (or related data) and other relevant information. In another embodiment, a player may carry a portable device, such as a cell phone, RFID or any other suitable wireless device which communicates a player's identification, credit totals (or related data) and other relevant information to the gaming device.

In one embodiment, one or more gaming devices are in communication with each other and/or at least one central server, central controller or remote host through a data network or remote communication link. In this embodiment, the central server, central controller or remote host is any suitable server or computing device which includes at least one processor and at least one memory or storage device. In different such embodiments, the central server is a progressive controller or a processor of one of the gaming devices in the gaming system. In these embodiments, the processor of each gaming device is designed to transmit and receive events, messages, commands or any other suitable data or signal between the individual gaming device and the central server. The gaming device processor is operable to execute such communicated events, messages or commands in conjunction with the operation of the gaming device. Moreover, the processor of the central server is designed to transmit and receive events, messages, commands or any other suitable data or signal between the central server and each of the individual gaming devices. The central server processor is operable to execute such communicated events, messages or commands in conjunction with the operation of the central server. It should be appreciated that one, more or each of the functions of the central controller as disclosed herein may be performed by one or more gaming device processors. It should be further appreciated that one, more or each of the functions of one or more gaming device processors as disclosed herein may be performed by the central controller.

In one embodiment, the game outcome provided to the player is determined by a central server or controller and provided to the player at the gaming device. In this embodiment, each of a plurality of such gaming devices are in communication with the central server or controller. Upon a player initiating game play at one of the gaming devices, the initiated gaming device communicates a game outcome request to the central server or controller.

In one embodiment, the central server or controller receives the game outcome request and randomly generates a game outcome for the game based on probability data. In this embodiment, the central server or controller is capable of storing and utilizing program code or other data similar to the processor and memory device of the gaming device.

In an alternative embodiment, the central server or controller maintains one or more predetermined pools or sets of predetermined game outcomes. In this embodiment, the central server or controller receives the game outcome request and independently selects a predetermined game outcome from a set or pool of game outcomes. The central server or controller flags or marks the selected game outcome as used. Once a game outcome is flagged as used, it is prevented from further selection from the set or pool and cannot be selected by the central controller or server upon another wager. The provided game outcome can include a primary game outcome, a secondary game outcome, primary and secondary game outcomes, or a series of game outcomes such as free games.

A gaming device as described herein can be configured to enable a player to immediately begin playing the game upon a wager on the game or a payment to play the game. In one embodiment, the player must make a minimum wager before the gaming device enables the game. That is, the processor does not designate a trigger symbol or display a set of matrix symbols until the player's wager meets a predetermined threshold. Instead, the system may provide the player with a set of standard reels unless and until the player's wager meets the predetermined threshold. In an alternative embodiment, the inventive game is configured as a secondary or bonus game. In one such embodiment, if a predetermined triggering event occurs in a primary game, the game device is configured to enable a player to play the inventive game. In one embodiment, the triggering event in the primary game may not occur until the player has made a minimum wager on the primary game.

The central server or controller communicates the generated or selected game outcome to the initiated gaming device. The gaming device receives the generated or selected game outcome and provides the game outcome to the player. In an alternative embodiment, how the generated or selected game outcome is to be presented or displayed to the player, is also determined by the central server or controller and communicated to the initiated gaming device to be presented or displayed to the player. Central production or control can assist a gaming establishment or other entity in maintaining appropriate records, controlling gaming, reducing and preventing cheating or electronic or other errors, reducing or eliminating win-loss volatility and the like.

In another embodiment, a predetermined game outcome value is determined for each of a plurality of linked or networked gaming devices based on the results of a bingo, keno or lottery game. In this embodiment, each individual gaming device utilizes one or more bingo, keno or lottery games to determine the predetermined game outcome value provided to the player for the interactive game played at that gaming device. In one embodiment, the bingo, keno or lottery game is displayed to the player. In another embodiment, the bingo, keno or lottery game is not displayed to the player, but the results of the bingo, keno or lottery game determine the predetermined game outcome value for the primary or secondary game.

In the various bingo embodiments, as each gaming device is enrolled in the bingo game, such as upon an appropriate wager or engaging an input device, the enrolled gaming device is provided or associated with a different bingo card. Each bingo card consists of a matrix or array of elements, wherein each element is designated with a separate indicia, such as a number. It should be appreciated that each different bingo card includes a different combination of elements. For example, if four bingo cards are provided to four enrolled gaming devices, the same element may be present on all four of the bingo cards while another element may solely be present on one of the bingo cards.

In operation of these embodiments, upon providing or associating a different bingo card to each of a plurality of enrolled gaming devices, the central controller randomly selects or draws, one at a time, a plurality of the elements. As each element is selected, a determination is made for each gaming device as to whether the selected element is present on the bingo card provided to that enrolled gaming device. This determination can be made by the central controller, the gaming device, a combination of the two, or in any other suitable manner. If the selected element is present on the bingo card provided to that enrolled gaming device, that selected element on the provided bingo card is marked or flagged. This process of selecting elements and marking any selected elements on the provided bingo cards continues until one or more predetermined patterns are marked on one or more of the provided bingo cards. It should be appreciated that in one embodiment, the gaming device requires the player to engage a daub button (not shown) to initiate the process of the gaming device marking or flagging any selected elements.

After one or more predetermined patterns are marked on one or more of the provided bingo cards, a game outcome is determined for each of the enrolled gaming devices based, at least in part, on the selected elements on the provided bingo cards. As described above, the game outcome determined for each gaming device enrolled in the bingo game is utilized by that gaming device to determine the predetermined game outcome provided to the player. For example, a first gaming device to have selected elements marked in a predetermined pattern is provided a first win outcome of $10 which will be provided to a first player regardless of how the first player plays in a first game and a second gaming device to have selected elements marked in a different predetermined pattern is provided a second win outcome of $2 which will be provided to a second player regardless of how the second player plays a second game. It should be appreciated that as the process of marking selected elements continues until one or more predetermined patterns are marked, this embodiment ensures that at least one bingo card will win the bingo game and thus at least one enrolled gaming device will provide a predetermined winning game outcome to a player. It should be appreciated that other suitable methods for selecting or determining one or more predetermined game outcomes may be employed.

In one example of the above-described embodiment, the predetermined game outcome may be based on a supplemental award in addition to any award provided for winning the bingo game as described above. In this embodiment, if one or more elements are marked in supplemental patterns within a designated number of drawn elements, a supplemental or intermittent award or value associated with the marked supplemental pattern is provided to the player as part of the predetermined game outcome. For example, if the four corners of a bingo card are marked within the first twenty selected elements, a supplemental award of $10 is provided to the player as part of the predetermined game outcome. It should be appreciated that in this embodiment, the player of a gaming device may be provided a supplemental or intermittent award regardless of if the enrolled gaming device's provided bingo card wins or does not win the bingo game as described above.

In another embodiment, one or more of the gaming devices are in communication with a central server or controller for monitoring purposes only. That is, each individual gaming device randomly generates the game outcomes to be provided to the player and the central server or controller monitors the activities and events occurring on the plurality of gaming devices. In one embodiment, the gaming network includes a real-time or on-line accounting and gaming information system operably coupled to the central server or controller. The accounting and gaming information system of this embodiment includes a player database for storing player profiles, a player tracking module for tracking players and a credit system for providing automated casino transactions.

In any of the discussed embodiments, a predetermined game outcome value is determined for each of a plurality of linked or networked gaming devices based on the results of a bingo, keno or lottery game and a predetermined set of reel strips will be displayed to the player in association with the predetermined game outcome. In this embodiment, the set of predetermined reel strips (and the reels in general) will not determine the win, but will instead be selected as a result of (or in association with) the win (the predetermined game outcome value). Thus, predetermined game outcome value of a bingo game is $10, the inventive system may select a set of reel strips that will display a visual pattern of symbols that equals a $10 win.

Many modifications and other embodiments of the invention will come to mind to one skilled in the art to which this invention pertains having the benefit of the teachings presented in the foregoing descriptions and the associated drawings. While examples discussed above cover the use of the invention in the context a content management service, the invention may be used in any other suitable context. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A gaming system comprising:
a. at least one input device;
b. at least one display device; and
c. at least one processor which is configured to:
i. receive a request, via the input device, from a user to play a first game;
ii. in response to the request, designate at least one symbol as a trigger symbol;
iii. in response to the request, display, on the display device, one of a plurality of symbols at each of a plurality of symbol display positions, wherein the plurality of symbol display positions form at least three columns and at least three rows including a first row, a second row positions adjacent to the first row, and a third row positioned adjacent to the second row;
iv. determine if any of the displayed symbols form any winning symbol combinations;
v. if the displayed symbols form at least one winning symbol combination, display one of a plurality of awards for each displayed winning symbol combination;
vi. determine if any winning symbol combination corresponds with at least one designated trigger symbol;
vii. if at least one winning symbol combination corresponds with at least one designated trigger symbol, remove at least one symbol which does not correspond with the designated trigger symbol from the plurality of symbol display positions;
viii. for each of any symbols removed from the first row of the symbol display positions, reposition at least one of the remaining displayed symbols to at least another one of the symbol display positions to create at least one empty symbol display position;
ix. for each of any symbols removed from the second row of the symbol display positions, reposition at least one of the remaining displayed symbols to at least another one of the symbol display positions to create at least one empty symbol display position;
x. determine if any of the displayed symbols form any winning symbol combinations;
xi. if the displayed symbols form at least one winning symbol combination, display one of a plurality of awards for each displayed winning symbol combination;
xii. if any empty symbol display positions remain, display one of a plurality of symbols at each of the empty symbol display positions; and
xiii. repeat steps (iv) through (xiii).

2. The system of claim 1, wherein the processor visually displays the designation of the at least one trigger symbol on the display device.

3. The system of claim 1, wherein the processor visually displays a trigger symbol area.

4. The system of claim 3, wherein the trigger symbol area is visually separate from the plurality of symbols at each of a plurality of symbol display positions.

5. The system of claim 1, wherein the processor designates two symbols as trigger symbols.

6. The system of claim 1, wherein the processor designates a plurality of symbols as trigger symbols.

7. The system of claim 1, wherein if the displayed symbols do not form a winning symbol combination, the game ends.

8. The system of claim 1, wherein any winning symbol combination corresponds with at least one designated trigger symbol if at least one symbol involved in the winning symbol combination is the same symbol as the designated trigger symbol.

9. The system of claim 1, wherein any winning symbol combination corresponds with at least one designated trigger symbol if at least one symbol involved in the winning symbol combination is related to the designated trigger symbol.

10. The system of claim 1, wherein all symbols which do not correspond with the designated trigger symbol are removed.

11. The system of claim 1, wherein all symbols which are not involved in a winning symbol combination are removed.

12. The system of claim 1, wherein all symbols which are not involved in a winning symbol combination or do not correspond with the designated trigger symbol are removed.

13. The system of claim 1, wherein step (xii) occurs before step (x).

14. A gaming system comprising:
a. at least one input device;
b. at least one display device; and
c. at least one processor which is configured to:
i. receive a request, via the input device, from a user to play a first game;
ii. in response to the request, display, on the display device, one of a plurality of symbols at each of a plurality of symbol display positions, wherein the plurality of symbol display positions form at least three columns and at least three rows including a first row, a second row positions adjacent to the first row, and a third row positioned adjacent to the second row;
iii. in response to the request, display a plurality of trigger symbols, visually located in an area separate from the plurality of symbols at each of the plurality of symbol display positions;
iv. in response to the request, designate at least one first symbol as a trigger symbol;
v. determine if any of the displayed symbols form any winning symbol combinations;
vi. if the displayed symbols form at least one winning symbol combination, display one of a plurality of awards for each displayed winning symbol combination;
vii. determine if any winning symbol combination corresponds with at least one designated trigger symbol;
viii. if at least one winning symbol combination corresponds with at least one designated trigger symbol, remove at least one symbol which does not correspond with the designated trigger symbol from the plurality of symbol display positions;
ix. for each of any symbols removed from the first row of the symbol display positions, reposition at least one of the remaining displayed symbols to at least another one of the symbol display positions to create at least one empty symbol display position;
x. for each of any symbols removed from the second row of the symbol display positions, reposition at least one of the remaining displayed symbols to at least another one of the symbol display positions to create at least one empty symbol display position;
xi. determine if any of the displayed symbols form any winning symbol combinations;
xii. if the displayed symbols form at least one winning symbol combination, display one of a plurality of awards for each displayed winning symbol combination;
xiii. remove the designation of the at least one first symbol as a trigger symbol and designate a different symbol as a trigger symbol;
xiv. if any empty symbol display positions remain, display one of a plurality of symbols at each of the empty symbol display positions; and
xv. repeat steps (iv) through (xiii).

15. The system of claim 14, wherein the display of the trigger symbols and the designation of at least one symbol as a trigger symbol occurs substantially simultaneous with the display of symbols at each of the plurality of symbol display positions.

16. The system of claim 14, wherein the symbols available for use as trigger symbols are a subset of the symbols available for use at each of the plurality of symbol display positions.

17. The system of claim 14, wherein the at least one designated trigger symbol is displayed as distinguishable from any other trigger symbols.

18. The system of claim 14, wherein step (xiv) occurs before step (xi).

19. A gaming system comprising:
a. at least one input device;
b. at least one display device; and
c. at least one processor which is configured to:
i. receive a request, via the input device, from a user to play a first game;
ii. in response to the request, designate a first symbol as a trigger symbol;
iii. in response to the request, display, on the display device, one of a plurality of symbols at each of a plurality of symbol display positions, wherein the plurality of symbol display positions form at least three columns and at least three rows including a first row, a second row positions adjacent to the first row, and a third row positioned adjacent to the second row;
iv. determine if any of the displayed symbols form any winning symbol combinations;
v. if the displayed symbols form at least one winning symbol combination, display one of a plurality of awards for each displayed winning symbol combination;
vi. determine if any winning symbol combination corresponds with at least one designated trigger symbol;
vii. if at least one winning symbol combination corresponds with at least one designated trigger symbol, remove at least one symbol which does not correspond with the designated trigger symbol from the plurality of symbol display positions;
viii. for each symbol removed from the first row of the symbol display positions, reposition at least one of the remaining displayed symbols to an empty symbol display position on the first row to create at least one empty symbol display position in the second or third row;
ix. for each symbol removed from the second row of the symbol display positions, reposition at least one of the remaining displayed symbols in the third row to any empty symbol display position on the second row to create at least one empty symbol display position in the third row;
x. if any empty symbol display positions remain, display one of a plurality of symbols at each of the empty symbol display positions;
xi. determine if any of the displayed symbols form any winning symbol combinations;
xii. if the displayed symbols form at least one winning symbol combination, display one of a plurality of awards for each displayed winning symbol combination;
xiii. designate an additional different symbol as a trigger symbol; and
xiv. repeat steps (iv) through (xiii).

20. The system of claim 19, wherein the repositioning of the remaining displayed symbols to another symbol display position comprises repositioning a displayed symbol to the lowest empty symbol display position.
